(19) United States
(12) Patent Application Publication
(10) Pub. No.: US 2024/0328229 A1
(43) Pub. Date: Oct. 3, 2024

(54) VEHICULAR CHARGE PORT DOOR WITH POWERED ACTUATOR

(71) Applicant: Magna Mirrors of America, Inc., Holland, MI (US)

(72) Inventors: Kenneth C. Peterson, Ada, MI (US); Connor G. Cervone, Byron Center, MI (US); Justin E. Sobecki, Rockford, MI (US); Bryce A. Hilborn, Grand Rapids, MI (US); Rudy A. Morey, Hudsonville, MI (US)

(21) Appl. No.: 18/619,751

(22) Filed: Mar. 28, 2024

Related U.S. Application Data
(60) Provisional application No. 63/496,031, filed on Apr. 14, 2023.
(60) Provisional application No. 63/495,619, filed on Apr. 12, 2023.
(60) Provisional application No. 63/495,315, filed on Apr. 11, 2023.
(60) Provisional application No. 63/493,409, filed on Mar. 31, 2023.
(60) Provisional application No. 63/493,327, filed on Mar. 31, 2023.

(51) Int. Cl. E05F 15/614; E05B 81/06; E05B 81/16; E05B 81/20; E05B 81/38; E05B 83/34

(52) U.S. Cl. CPC E05F 15/614; E05B 81/06; E05B 81/16; E05B 81/20; E05B 81/38; E05B 83/34; E05Y 2201/216; E05Y 2201/712; E05Y 2201/722; E05Y 2400/31; E05Y 2400/326; E05Y 2900/534

(57) ABSTRACT

A vehicular closure system includes a cover panel disposed at a charge port of a vehicle and movable between a closed position, where the cover panel conceals the charge port, and an opened position. An actuator is operable to move the cover panel between the closed and opened positions. A motor of the actuator rotates an output gear about an axis of rotation. An output element is connected to the cover panel and rotates about the axis of rotation as the cover panel moves. When the motor of the actuator is operated to move the cover panel, the output element rotates in tandem with the output gear. When the cover panel is manually moved, the output element rotates about the axis of rotation relative to the output gear.

### CROSS REFERENCE TO RELATED APPLICATIONS

The present application claims the filing benefits of U.S. provisional application Ser. No. 63/496,031, filed Apr. 14, 2023, U.S. provisional application Ser. No. 63/495,619, filed Apr. 12, 2023, U.S. provisional application Ser. No. 63/495,315, filed Apr. 11, 2023, U.S. provisional application Ser. No. 63/493,409, filed Mar. 31, 2023, and U.S. provisional application Ser. No. 63/493,327, filed Mar. 31, 2023, which are all hereby incorporated herein by reference in their entireties.

### FIELD OF THE INVENTION

The present invention relates to a charge port or fuel port of a vehicle.

### BACKGROUND OF THE INVENTION

It is known to cover or conceal a fuel port of a vehicle or a charging port of an electric vehicle with a flap or door that is pivotable relative to the port between a closed position, where the flap is disposed over the port to cover and conceal the port, and an opened position, where the flap is pivoted away from the port to expose the port for receiving a fuel source or electrical connector of a charging station. Commonly, the flap is located at the side of the vehicle and is manually pivotable between the closed and opened positions.

### SUMMARY OF THE INVENTION

An example of a vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. An actuator assembly is electrically operable to move the cover panel between the closed position and the opened position. The actuator assembly includes an electrically operable motor that, when electrically operated to move the cover panel between the closed position and the opened position, drives an output gear of the actuator assembly, whereby the output gear rotates about an axis of rotation of the actuator assembly. An output element of the actuator assembly is coupled to the cover panel, and the output element, as the cover panel moves between the closed position and the opened position, rotates about the axis of rotation of the actuator assembly. When the actuator assembly is electrically operated to move the cover panel between the closed position and the opened position, the output element is rotationally coupled to the output gear and the electrically operable motor drives the output gear to impart rotation of the output element about the axis of rotation to move the cover panel between the closed position and the opened position. When the cover panel is manually moved between the closed position and the opened position, the output element is not rotationally coupled to the output gear and the output element rotates about the axis of rotation relative to the output gear as the cover panel is manually moved between the closed position and the opened position.

Another example of a vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. The cover panel is mounted to a base portion at the vehicle, and the cover panel is movable between the closed position and the opened position relative to the base portion. An actuator assembly is electrically operable to move the cover panel between the closed position and the opened position. The actuator assembly includes an electrically operable motor that, when electrically operated to move the cover panel between the closed position and the opened position, drives an output gear of the actuator assembly. The output gear rotates about an axis of rotation of the actuator assembly. An output element of the actuator assembly is connected to the cover panel. When the actuator assembly is electrically operated to move the cover panel between the closed position and the opened position, the output gear drives the output element about the axis of rotation of the actuator assembly to move the cover panel between the closed position and the opened position. A locking element is disposed at the base portion. The locking element is movable between (i) a locked state, where, with the cover panel in the closed position, the locking element is engaged with a retaining element of the cover panel to secure the cover panel in the closed position, and (ii) an unlocked state, where the locking element is moved out of engagement with the retaining element of the cover panel to allow the cover panel to move between the closed position and the opened position. With the cover panel in the closed position, the actuator assembly is electrically operable to drive the output gear to move the locking element between the locked state and the unlocked state.

Yet another example of a vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. The cover panel is pivotally mounted to a base portion at the vehicle. When the cover panel moves between the closed position and the opened position, the cover panel pivots about a pivot axis relative to the base portion. An actuator assembly is electrically operable to move the cover panel between the closed position and the opened position. The actuator assembly includes an electrically operable motor that, when electrically operated to move the cover panel between the closed position and the opened position, drives a drive shaft of the actuator assembly. The drive shaft rotates about an axis of rotation of the actuator assembly. The pivot axis of the cover panel is offset from the axis of rotation of the actuator assembly. A pivot link is connected to the cover panel and the drive shaft. The pivot link includes a first portion that is coupled to the drive shaft and that pivots about the axis of rotation of the actuator assembly according to rotation of the drive shaft. A second portion of the pivot link has a first end pivotally connected to the first portion and a second end opposite the first end that is pivotally connected to the cover panel. The electrically operable motor, when electrically operated to move the cover panel between the closed position and the opened position, drives the drive shaft and the first portion of the pivot link about the axis of rotation of the actuator to impart movement of the cover panel about the pivot axis of the cover panel via the second portion of the pivot link. When the cover panel moves between the closed position and the opened position, the first end of the second portion of the pivot link moves about the axis of rotation of the actuator assembly and the second end of the second portion of the pivot link moves about the pivot axis of the cover panel.

An example of a vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. The cover panel is pivotally mounted to a base portion at the vehicle. When the cover panel moves between the closed position and the opened position, the cover panel pivots about a pivot axis relative to the base portion. An actuator assembly is electrically operable to move the cover panel between the closed position and the opened position. The actuator assembly includes an electrically operable motor that, when electrically operated to move the cover panel between the closed position and the opened position, drives a gear train to drive an output gear, and wherein the output gear rotates about an axis of rotation of the actuator assembly. The electrically operable motor, when electrically operated to move the cover panel between the closed position and the opened position, provides a constant torque output to drive the gear train. An output element of the actuator assembly is connected to the cover panel, and the output element, as the cover panel moves between the closed position and the opened position, rotates about the axis of rotation of the actuator assembly. When the actuator assembly is electrically operated to move the cover panel between the closed position and the opened position, the electrically operable motor drives the gear train to drive the output gear to impart rotation of the output element about the axis of rotation to move the cover panel between the closed position and the opened position. The output gear of the actuator assembly includes a variable gear profile so that, as the electrically operable motor drives the gear train to drive the output gear to move the cover panel between the closed position and the opened position, the output element provides a non-constant torque output at the cover panel.

Another example of a vehicular closure system for a charge port cover panel includes a cover panel disposed at a vehicle equipped with the vehicular closure system. The cover panel is movable between (i) a closed position, where the cover panel conceals a charge port of the vehicle, and (ii) an opened position, where the cover panel is moved away from the charge port to allow access to a charging connector of the charge port. The cover panel is pivotally mounted to a base portion at the vehicle. When the cover panel moves between the closed position and the opened position, the cover panel pivots about a pivot axis relative to the base portion. An actuator assembly is electrically operable to move the cover panel between the closed position and the opened position. The actuator assembly includes an electrically operable motor that, when electrically operated to move the cover panel between the closed position and the opened position, drives a gear train of the actuator assembly. An output shaft of the actuator assembly is coupled to the cover panel and moves together and in tandem with the cover pane as the cover panel moves between the closed position and the opened position. The gear train of the actuator assembly is coupled to a rack that extends along a longitudinal axis of the actuator assembly. The rack is coupled to the output shaft and moves with the output shaft along the longitudinal axis as the cover panel moves between the closed position and the opened position. The gear train of the actuator assembly, when the electrically operable motor is electrically operated and drives the gear train, drives the rack to move the output shaft along the longitudinal axis to move the cover panel between the closed position and the opened position. Further, a channel may be formed along an outer surface of the output shaft and a guide pin is received along the channel. As the output shaft moves along the longitudinal axis to move the cover panel between the closed position and the opened position, the guide pin moves along the channel to guide rotation of the output shaft and cover panel about the longitudinal axis.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with an example of a vehicular electric charging system;

FIG. 2 is a perspective view of an electrically operable actuator of the vehicular electric charging system;

FIG. 3 is a plan view of the electrically operable actuator, with an upper housing removed to show the motor, gear train, and output element of the actuator;

FIG. 4 is an exploded view of the electrically operable actuator;

FIG. 5 is a perspective view of the motor, gear train, and output element of the electrically operable actuator;

FIG. 6 is a sectional view of the output element of the electrically operable actuator;

FIG. 7 is an exploded view of the output element of FIG. 6;

FIG. 8 is a sectional view of another output element;

FIG. 9 is an exploded view of the output element of FIG. 8;

FIG. 10 is a perspective view of the printed circuit board of the electrically operable actuator with a magnetic position sensor;

FIG. 11 is a perspective view of the printed circuit board of the electrically operable actuator with a potentiometer position sensor;

FIG. 12 is a plan view of a vehicle with another example of a vehicular electric charging system;

FIG. 13 is a perspective view of a charge port of the vehicular electric charging system of FIG. 12, with a cover panel of the charge port in a closed position;

FIG. 14 is a perspective view of the charge port with the cover panel in an opened position;

FIG. 15 is a perspective view of the cover panel;

FIG. 16 is a perspective view of an actuator of the charge port that is operable to move the cover panel between the closed position and the opened position;

FIG. 17 is an exploded view of the actuator;

FIG. 18 is an exploded view of the cover panel and a locking mechanism of the actuator;

FIGS. 19A and 20A are perspective views of the charge port with the cover panel in the closed position and the locking mechanism in a locked state;

FIGS. 19B and 20B are perspective views of the charge port with the locking mechanism moved to an unlocked state and the cover panel moved toward the opened position;

FIGS. 21A and 21B are sectional views of the charge port with the cover panel in the closed position and the locking mechanism in the locked state;

FIGS. 22A and 22B are sectional views of the charge port with the locking mechanism moved to the unlocked state and the cover panel moved toward the opened position;

FIG. 23 is a plan view of a vehicle with another example of a vehicular electric charging system;

FIG. 24 is a perspective view of a charge port of the vehicular electric charging system of FIG. 23, with a cover panel of the charge port in a closed position;

FIG. 25 is a perspective view of the charge port, with the cover panel in an opened position;

FIGS. 26 and 27 are views of another example of the charge port with an electrically operable actuator, where the cover panel pivots about a pivot axis and the actuator drives a drive shaft about the pivot axis of the cover panel to move the cover panel between the closed position and the opened position;

FIGS. 28 and 29 are perspective views of the charge port of the vehicular electric charging system of FIG. 23, with an electrically operable actuator that drives a drive shaft about an axis of rotation that is offset from the pivot axis of the cover panel and a connecting link is pivotally connected to the cover panel and the drive shaft so that rotation of the drive shaft imparts movement of the cover panel about the pivot axis;

FIG. 30 is a plan view of the charge port of FIGS. 28 and 29 in the closed position;

FIG. 31 is a plan view of the charge port of FIGS. 28 and 29 in the opened position;

FIG. 32 is an exploded view of the charge port of FIGS. 28 and 29;

FIG. 33 is another perspective view of the charge port of FIGS. 28 and 29;

FIG. 34 is another exploded view of the charge port of FIGS. 28 and 29;

FIG. 35 is another plan view of the charge port of FIGS. 28 and 29 in the closed position;

FIGS. 36 and 37 are perspective views of the charge port of FIGS. 28 and 29, showing the connecting link pivotally connected to the drive shaft and the hinge arm of the cover panel;

FIG. 38 is a plan view of a vehicle with another example of a vehicular electric charging system;

FIG. 39A is a perspective view of a transmission configured to adjust gear ratios for output of an actuator, where the transmission is providing a first gear ratio;

FIG. 39B is a perspective view of the transmission of FIG. 39A, where the transmission is providing a second gear ratio;

FIGS. 40 and 41 are perspective views of additional actuators configured to adjust gear ratios for output of the respective actuators;

FIG. 42A is a perspective view of another actuator, with a housing portion of the actuator removed to show a gear train of the actuator that includes variable ratio output gears, where the actuator is shown with the variable ratio output gears in a high output torque position;

FIG. 42B is a perspective view of the actuator of FIG. 42A, where the actuator is shown with the variable ratio output gears in a high output speed position;

FIGS. 43 and 44 are perspective views of the gear train of the actuator of FIGS. 42A and 42B;

FIG. 45 is an exploded view of the actuator of FIGS. 42A and 42B;

FIG. 46 includes a diagram representing output speed of the actuator as the cover panel moves between the closed position and the opened position;

FIG. 47 includes a diagram representing the output speed of the actuator based on the input speed of the motor during rotation of the variable ratio output gears relative to one another;

FIG. 48 is a plan view of a vehicle with another example of a vehicular electric charging system;

FIGS. 49-52 are views of an actuator that is electrically operable to move a cover panel of the vehicular electric charging system of FIG. 48 between a closed position and an opened position;

FIGS. 53-56 are views of a gear train of the actuator;

FIG. 57 is an exploded view of the actuator;

FIG. 58 is a perspective view of the actuator and the cover panel;

FIGS. 59A-59D are perspective views of the actuator and the cover panel as the actuator moves the cover panel between the closed position (FIG. 59A) and the opened position (FIG. 59D);

FIG. 60 is a perspective view of a lower housing portion of the actuator;

FIG. 61 is a perspective view of a shaft of the actuator that interfaces with the cover panel;

FIG. 62 is a sectional view of the shaft along a channel of the lower housing portion and with a pin structure of the lower housing portion received along a slot formed along the outer surface of the shaft;

FIG. 63 is a sectional view of the actuator;

FIG. 64 is a plan view of the actuator, with an upper housing portion removed to show the gear train of the actuator;

FIG. 65 is a perspective view of a clutch gear of the gear train of the actuator;

FIG. 66 is a perspective view of a memory portion of the gear train of the actuator;

FIG. 68 is a side view of the actuator and cover panel, showing a range of travel of the cover panel during operation of the actuator;

FIG. 67 is another exploded view of the actuator;

FIGS. 69-72 are views of the actuator and cover panel, showing example dimensions of the actuator and cover panel;

FIGS. 73A and 73B show a comparison between the dimensional footprint of the actuator and the footprint of a larger actuator;

FIGS. 74A and 74B show a comparison between the dimensional footprint of the actuator and the footprint of another larger actuator;

FIG. 75 includes a diagram that includes torque outputs for the actuator and forces for manually closing the cover panel; and

FIG. 76 includes a diagram that includes rates for moving the cover panel from the closed position to the opened position via electrical operation of the actuator.

### DESCRIPTION OF THE PREFERRED EMBODIMENTS

A vehicular electric charging charge port opening system operates to open and/or close a power charge flap or panel of an electrically powered vehicle that covers a charging connector configured to electrically connect with an electrical connector of a charging wand to charge batteries of the electrically powered vehicle. Aspects of the power charge flap described herein may also be suitable for use with a fuel port cover for covering a fuel filler port or opening of a vehicle that is configured to receive a nozzle that delivers fuel (e.g., gasoline) to a fuel tank of the vehicle via the fuel port.

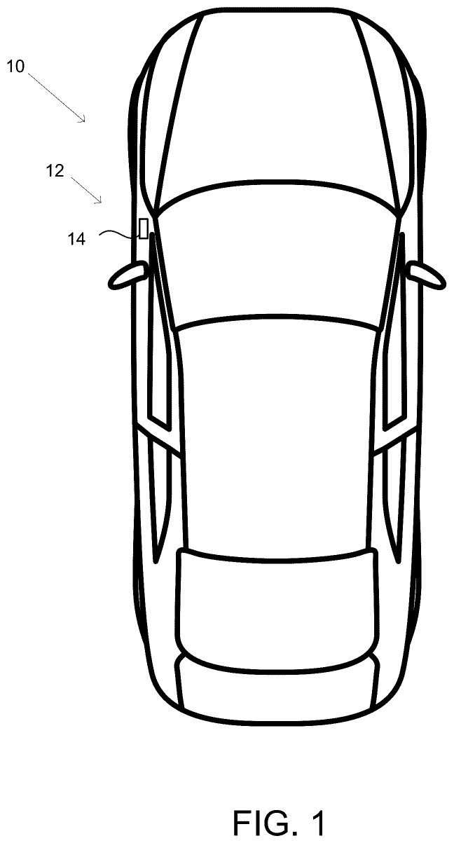

Referring now to the drawings and illustrative embodiments depicted therein, a vehicle 10 (e.g., an electric vehicle or EV, or a plug-in hybrid vehicle or PHEV) includes an electrical charging system or charge port 12 that includes a base portion or bracket (not shown) and a cover panel or flap 14 (FIG. 1). For example, the panel 14 is pivotably mounted at the vehicle or the base portion and has an outer surface that, when the panel 14 is in a closed position, corresponds with and/or is substantially flush with an outer surface of the exterior panel(s) of the vehicle 10 at and around the charge port 12 of the vehicle. When in the closed position, the cover panel 14 conceals a charging connector (not shown) of the charge port 12 that is configured or operable to electrically connect with an electrical connector or charging wand (not shown) of a charging station or system to charge batteries of the vehicle 10. When in an open position, the cover panel 14 may be moved relative to the base portion and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector.

As shown in FIG. 1, the charge port 12 may be disposed along a side of the vehicle 10 (such as at a front driver side portion of the vehicle) and, when the cover panel 14 is in the closed position, the exterior surface of the panel 14 is substantially flush with and corresponds to the exterior surface of the vehicle 10 and/or the base portion at or surrounding the charge port 12. The charge port 12 may be disposed at any suitable position at the exterior of the vehicle. For example, the charge port 12 may be disposed at the front or rear fender or bumper of the vehicle. Optionally, the charge port 12 may be concealed behind an exterior feature of the vehicle 10, such as a manufacturers emblem, a portion of a headlight or taillight, a license plate bracket, or the like, where the closure system enables movement of the exterior feature between the closed and opened positions.

When the cover panel 14 is in the closed position, the cover panel 14 may at least partially compress a sealing element or gasket between a rear or interior side or an edge region of the cover panel 14 and the base portion or side of the vehicle surrounding the charge port 12 to protect the connector portion and limit or preclude moisture and contaminants from entering the charge port 12 when the cover panel 14 is closed. For example, the sealing element may be disposed at the interior side of the cover panel 14 or at the base portion and configured to at least partially circumscribe the connector when the cover panel 14 is closed.

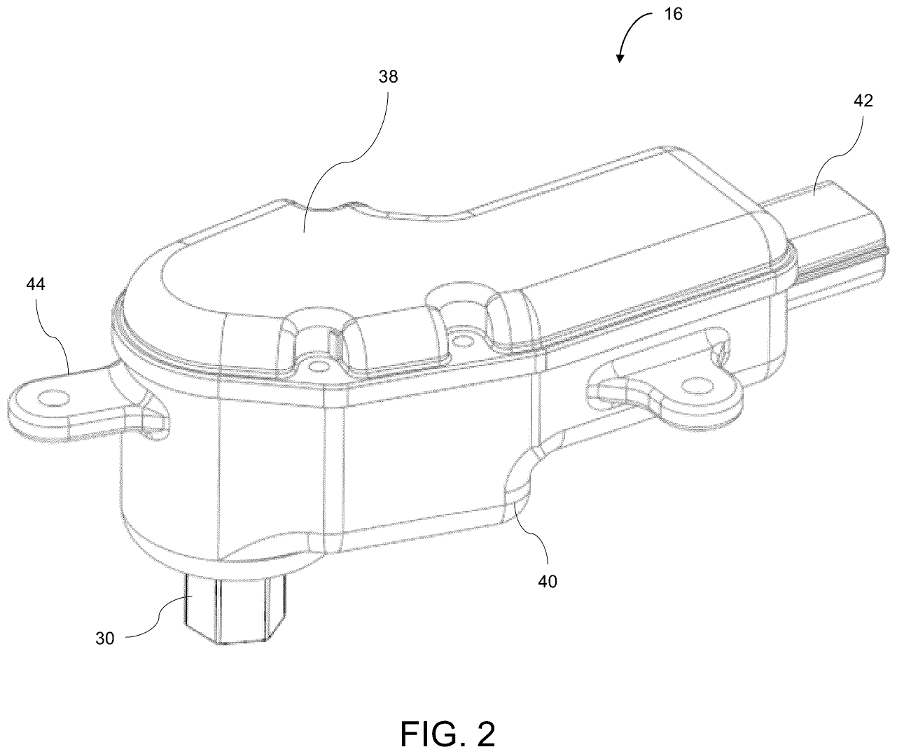

The cover panel 14 is movable between the closed position and the opened position via operation of an electrically operable actuator 16 (FIG. 2), which may be electrically operated to move the cover panel 14 in response to a user input. For example, the actuator may deploy the cover panel 14 in response to a user input at a key fob associated with the vehicle, a button or sensor at the exterior surface of the charge port 12 or vehicle, or a button at the interior of the vehicle cabin, or the actuator may provide a passive opening system, where the actuator operates responsive to a sensor (e.g., a proximity sensor) that senses the user or fob when the user or fob (or other communication device or sensed element) approaches the charge port and/or is within a threshold distance to the charge port. When actuated, the actuator (such as an electrically operable motor of the actuator) operates to move the cover panel 14 from the closed position toward the opened position, and the cover panel may move relative to the base portion or vehicle in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication No. US-2023-0191926 and/or U.S. patent application Ser. No. 18/476,632, filed Sep. 28, 2023 (Attorney Docket DON10 P4918), Ser. No. 18/419,751, filed Jan. 23, 2024 (Attorney Docket DON09 P5045), and/or Ser. No. 18/443,744, filed Feb. 16, 2024 (Attorney Docket DON10 P5080), and/or U.S. provisional application Ser. No. 63/497,457, filed Apr. 21, 2023, which are hereby incorporated herein by reference in their entireties.

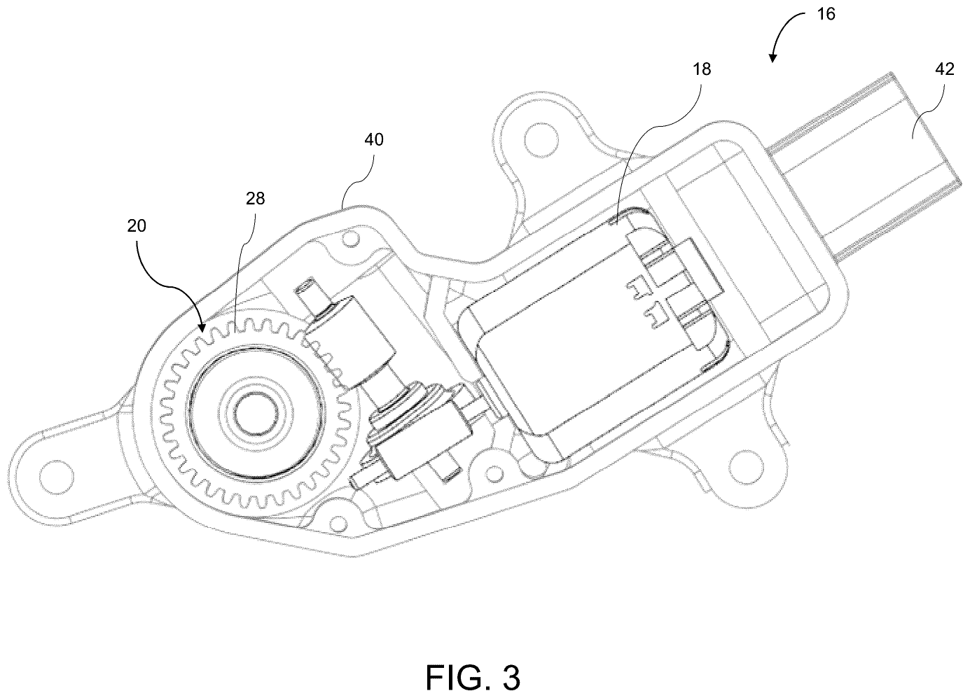

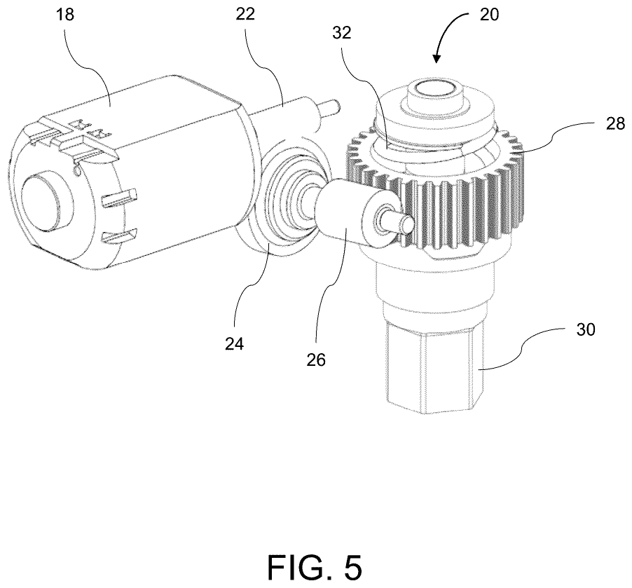

Referring to FIGS. 2-5, the actuator 16 includes an electrically operable motor 18 that, when the actuator 16 is electrically operated to move the cover panel 14 between the closed position and the opened position, is electrically operated to impart rotation of an output element 20 of the actuator 16. When the output element 20 is rotatably driven by the motor 18, the output element 20 imparts movement of the cover panel 14 relative to the base portion and/or the side of the vehicle at which the charge port 12 is disposed. For example, the actuator 16 may rotatably drive a helical element that engages a portion of the cover panel 14 to move the cover panel when the helical element is rotated. Optionally, the actuator 16 drives a linear output element that, when driven by the actuator 16, moves axially relative to the actuator and cover panel to move the cover panel between the closed position and the opened position. The linear actuator may utilize aspects of the actuators described in U.S. Publication Nos. US-2023-0027125 and/or US-2022-0341226, and/or U.S. patent application Ser. No. 18/359,114, filed Jul. 26, 2023 (Attorney Docket DON05 P4888), Ser. No. 18/476,632, filed Sep. 28, 2023 (Attorney Docket DON10 P4918), Ser. No. 18/414,533, filed Jan. 17, 2024 (Attorney Docket DON08 P5038), and/or Ser. No. 18/416,029, filed Jan. 18, 2024 (Attorney Docket DON08 P5040), which are hereby incorporated herein by reference in their entireties.

As discussed further below, the actuator 16 includes a detent mechanism or interface or clutch subassembly disposed between the motor 18 and the output of the actuator so that, when a torque load at the cover panel 14 overcomes a frictional or retaining force of the detent interface (e.g., when ice build-up is present at the cover panel or when the cover panel is manually moved between the closed position and the opened position), the detent interface disengages to prevent damage to the motor 18. That is, the detent interface disengages when the torque load at the cover panel 14 is greater than a threshold level of torque, such as when a load at the cover panel resists movement from the closed position to the opened position or when the cover panel is manually moved, to prevent or preclude transfer of torque from the cover panel through the output to the motor 18.

For example, the motor 18, when electrically operated, drives a worm gear element 22 coupled to a drive shaft of the motor 18, which in turn drives a gear train that engages the output element 20. The worm gear 22 engages and drives a helical gear 24. The helical gear 24 is coupled to an output worm 26 that engages and drives an output gear 28 of the output element 20.

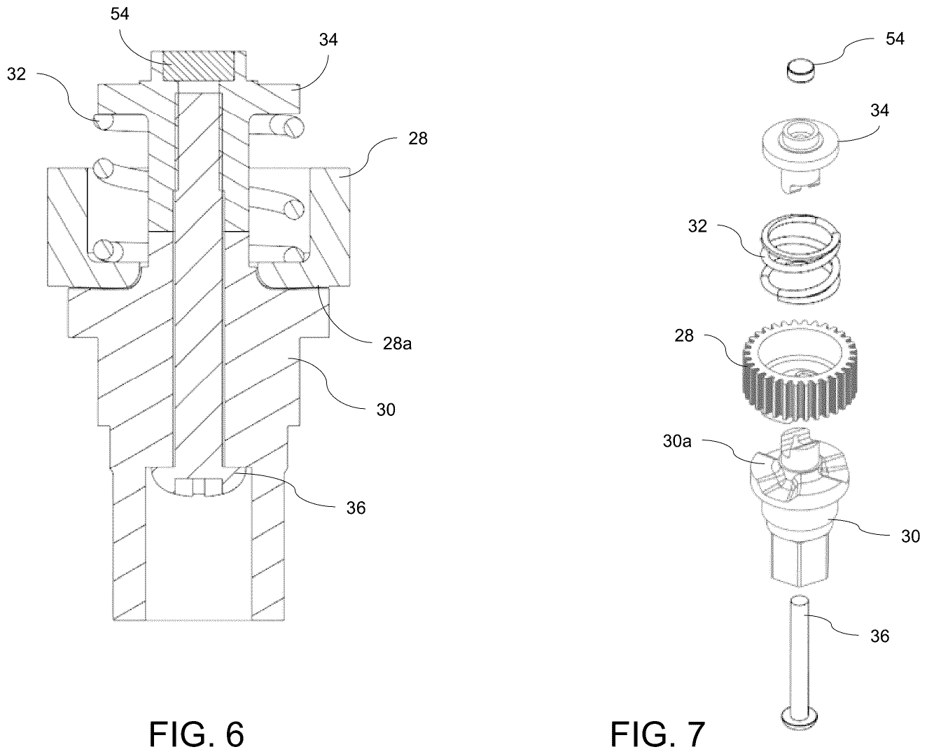

The output element or clutch subassembly 20 includes an output shaft portion 30 that, when rotated, imparts movement of the cover panel 14 between the closed position and the opened position. As shown in FIGS. 6 and 7, the output shaft portion 30 includes a detent surface 30a that engages a corresponding detent surface 28a of the output gear 28. For example, the upper surface of the output shaft portion 30 engages the lower surface of the output gear 28. A biasing element or detent spring 32 (e.g., a coil spring or other suitable biasing element) biases the detent interface into engagement so that, when the detent surface 30a of the output shaft portion 30 is engaged with the detent surface 28a of the output gear 28 and when the output gear 28 is rotatably driven by the motor 18 via the gear train, the output shaft portion 30 rotates according to rotation of the output gear 28.

When the torque load at the cover panel 14 is greater than the retaining or frictional force at the detent interface and the biasing force from the biasing element (such as when there is ice build-up at the outer surface of the cover panel or when the cover panel engages an object during its opening or closing motion or when the cover panel is manually moved between the closed position and the opened position), the output shaft portion 30 and the output gear 28 slip relative to one another. As the detent surfaces of the output shaft portion 30 and the output gear 28 move relative to one another about a pivot axis of the output element 20, the detents ride along one another and force the output shaft portion 30 and the output gear 28 to separate or move away from one another along the pivot axis to disengage the output gear 28 (and therefore the motor 18) from the output shaft portion 30.

In the illustrated example of FIGS. 6 and 7, a retaining element or spring retainer 34 is disposed at an opposite side of the output gear 28 from the output shaft portion 30, with the biasing element 32 disposed between the retaining element 34 and the output gear 28 to urge the output gear 28 away from the retaining element 34 and toward the output shaft portion 30. A screw or other suitable threaded fastener 36 extends along the pivot axis of the output element 20 and through the output shaft portion 30 and the output gear 28 and engages the retaining element 34 to longitudinally secure the output shaft portion 30 and the retaining element 34 relative to one another along the pivot axis. The retaining element 34 and the output shaft portion 30 may be keyed together or rotationally fixed relative to one another so that the retaining element 34 and the output shaft portion 30 rotate about the pivot axis together and in tandem with one another.

The biasing element 32 may be disposed at least partially within a recess or receiving portion of the output gear 28 and, with the detent interface engaged, there may be a gap between an upper end of the output gear 28 and the retaining element 34. Thus, when the detent interface disengages and the output gear 28 separates from the output shaft portion 30, the output gear 28 moves along the pivot axis toward the retaining element 34 and away from the output shaft portion 30. That is, when the output shaft portion 30 rotates relative to the output gear 28, the detents ride along one another and the output gear 28 moves axially away from the output shaft portion 30 along the retaining element 34 and/or the threaded fastener 36 and against the biasing force of the biasing element 32.

The output shaft portion 30 may be keyed to or coupled with the cover panel 14 such that the output shaft portion 30 rotates as the cover panel 14 moves between the closed position and the opened position. Thus, for example, when the cover panel 14 is manually moved from the closed position to the opened position and the output gear 28 disengages from the output shaft portion 30, the output shaft portion 30 may rotate as the cover panel is moved without imparting force on the motor through the output gear and gear train. When the cover panel 14 is manually moved back to its previous position (e.g., the closed position or the opened position), or when the motor 18 is next operated to drive the output gear 28, the detent interface may move back into engagement so that operation of the motor 18 may move the cover panel 14. Optionally, the detent surfaces may be configured such that the biasing element 32 urges the detent interface back into engagement when the torque load is released or decreases below a threshold amount. Thus, the detent interface may be engaged so that operation of the motor 18 may move the cover panel with the cover panel in an intermediate position between the closed position and the opened position. The retaining force or frictional force when the detent interface is engaged may retain the cover panel 14 in the closed position or the opened position when the actuator 16 is operated to move the cover panel 14 to the closed position or the opened position, or in the intermediate position when movement of the cover panel 14 is stopped between the opened position and the closed position, such as due to manual movement or due to the cover panel 14 contacting an obstacle.

As shown in FIGS. 2-4, the actuator 16 includes a housing, such as an upper housing 38 and a lower housing 40 that mate to one another to define an interior portion or cavity that accommodates the motor 18, the gear train, and at least a portion of the output element 20. The output shaft portion 30 of the output element may extend from the housing (such as through an aperture in the lower housing 40) and rotate relative to the housing. Further, the housing may include a connector portion 42 configured to receive an electrical connector for electrically connecting the actuator 16 to a power source of the vehicle. The connector portion 42 may connect the actuator 16 to an electronic control unit (ECU) at the vehicle for receiving and transmitting signals related to control of the actuator 16. Optionally, the housing may include one or more attachment flanges 44 configured to receive a fastener (e.g., a screw or other suitable threaded fastener) for securing the actuator 16 at the vehicle, such as at the base portion of the charge port 12.

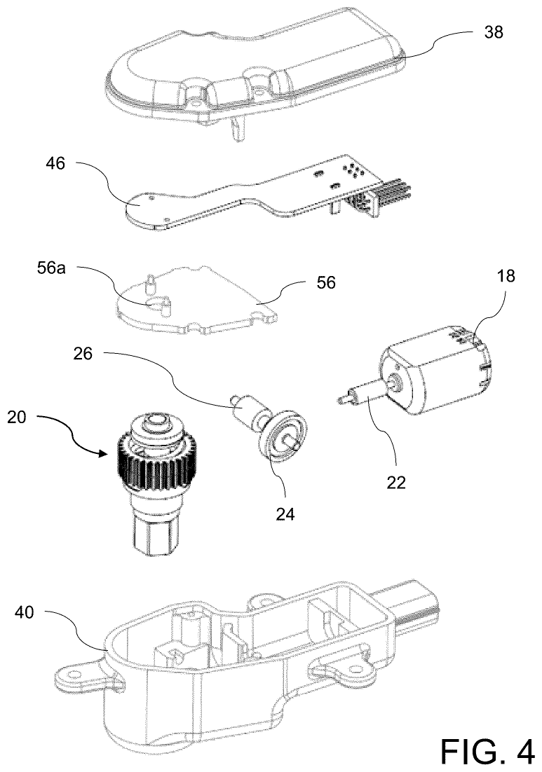

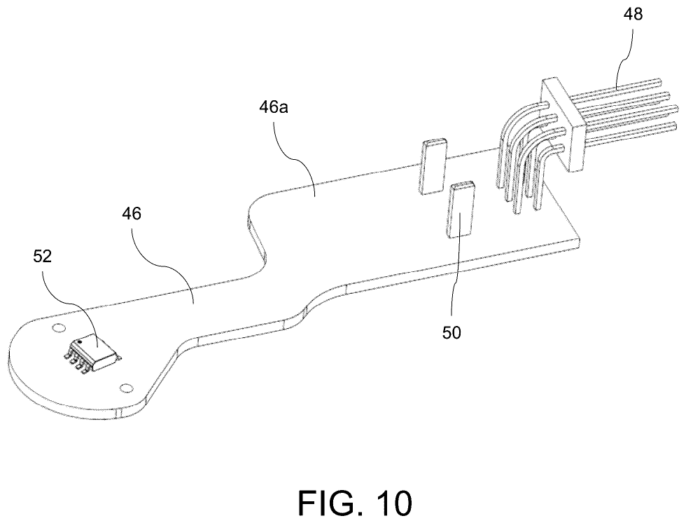

Referring to FIGS. 4 and 10, the actuator housing accommodates a printed circuit board (PCB) 46 that is electrically connected to the connector portion 42 and the motor 18. For example, one or more first electrical terminals 48 extend from a first side 46a of the PCB 46 and at least partially into or within the connector portion 42, where the first terminals 48 may electrically couple to an outlet of the connector portion 42 or directly electrically connect to the vehicle connector received at the connector portion 42. One or more second electrical terminals 50 extend from the first side 46a and electrically connect to the motor 18 to electrically power the motor 18.

Optionally, a position sensor 52 is disposed at the first side 46a of the PCB 46 at a position corresponding to the output element 20 and facing the output element 20. The position sensor 52 is configured to detect or sense a position of the output element 20 relative to the PCB 46 to determine a position of the cover panel 14 relative to the vehicle. The PCB 46 may communicate the detected position to the vehicle ECU.

In the illustrated example of FIG. 10, the position sensor 52 includes a Hall sensor or a magnetoresistive position sensor that provides magnetic position sensing. A diametric magnet 54 is positioned on the end of the output element 20 to rotate with the output shaft portion 30 (such as at the retaining element 34 that is rotationally keyed to the output shaft portion 30) and, based on a strength or position of the magnetic field 54 detected by the Hall sensor 52, the rotational position of the output element 20 relative to the actuator 16 is determined. Thus, the magnet 54 (and optionally the retaining element 34) may rotate together and in tandem with the output shaft portion 30 of the output element 20.

Optionally, a secondary PCB 56 may be disposed between the PCB 46 and the output element 20. As shown in FIG. 4, the secondary PCB 56 includes an aperture 56a that aligns with the magnet 54 so that the Hall sensor 52 may sense the position of the magnet 54 relative to the PCB 46 through the aperture 56a in the secondary PCB 56.

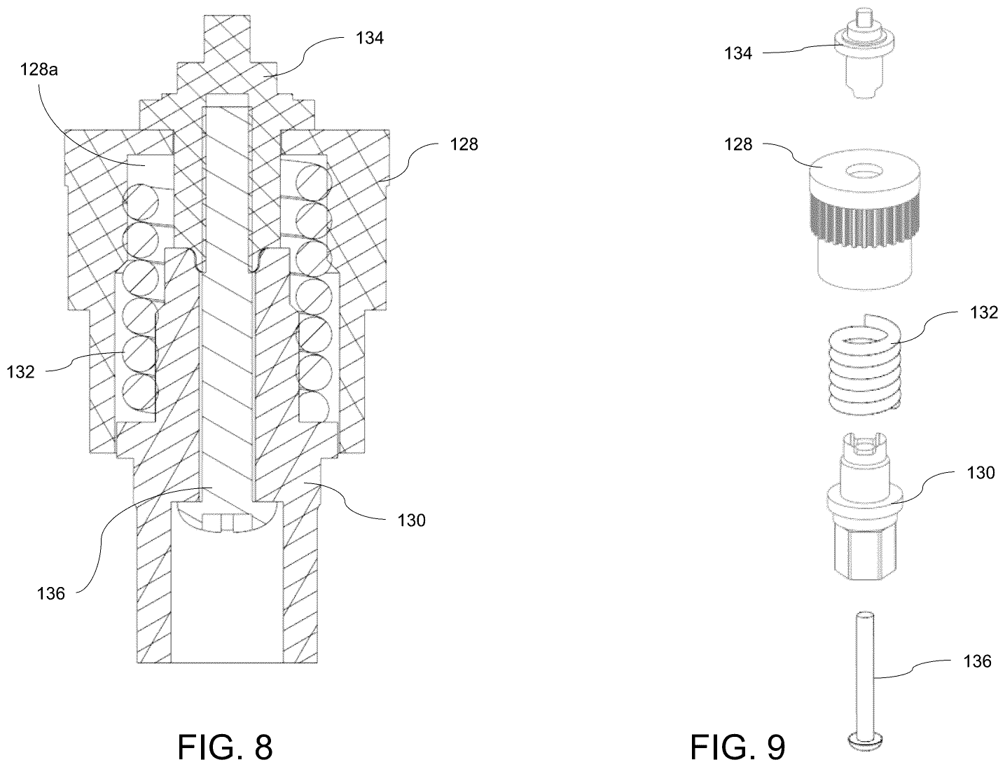

In some examples, a frictional interface may be disposed between the output shaft portion and the output gear so that the output shaft portion and the output gear rotationally slip relative to one another responsive to the torque load at the cover panel. For example and referring to FIGS. 8 and 9, an output element 120 may include an output gear 128 that includes a bore or recess portion 128a, where at least a portion of the output shaft portion 130 is received within the bore 128a and the biasing element (e.g., a wrap spring or clutch spring or coil spring) 132 is received within the bore 128a between the output shaft portion 130 and an interior surface of the output gear 128. A gear retainer or retaining element 134 is disposed at an upper portion of the output gear 128 and extends at least partially into the bore 128a to receive a screw (or other suitable threaded fastener) 136 that extends through the output shaft portion 130 and output gear 128 to secure the retaining element 134 and the output shaft portion 130 relative to one another along the pivot axis of the output element 120. The biasing element 132 circumscribes the part of the output shaft portion 130 and the retaining element 134 received within the bore 128a.

The retaining element 134 and the output shaft portion 130 may be keyed together or rotationally fixed relative to one another so that the retaining element 134 and output shaft portion 130 rotate about the pivot axis together and in tandem with one another.

The biasing element 132 is at least partially compressed between an inner cylindrical surface of the output gear 128 that defines the bore 128a and the outer cylindrical surface of the output shaft portion 130 so that the output gear 128 and the output shaft portion 130 may rotate together and in tandem when the output gear 128 is rotatably driven by the actuator. When the torque load at the output shaft portion 130 overcomes the frictional force between the biasing element 132 and the output gear 128 and/or the frictional force between the biasing element 132 and the output shaft portion 130, the output shaft portion 130 and the output gear 128 slip relative to one another. Thus, the biasing element 132 may provide a frictional interface having a consistent or substantially equal release threshold (i.e., the amount of torque that causes the output element to slip) in both rotational directions of the output element (e.g., when the cover element is manually moved in a first direction from the closed position toward the opened position and when the cover element is manually moved in an opposite second direction from the opened position toward the closed position).

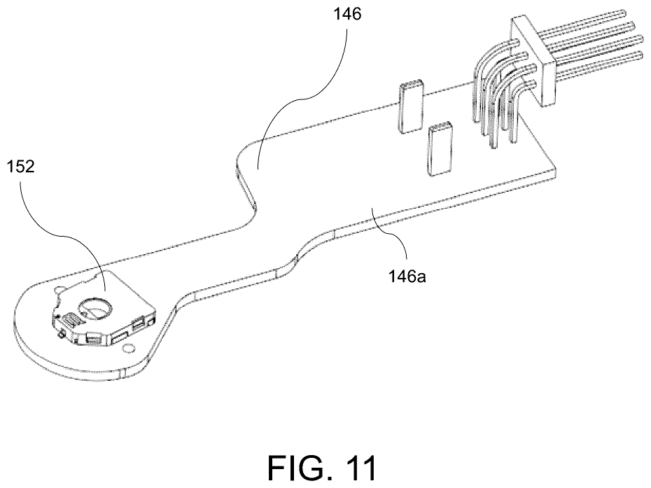

Optionally, and such as shown in FIG. 11, the position sensor may include a potentiometer 152 disposed at the first side 146a of the PCB 146. The potentiometer 152 interfaces with an end portion of the output element 120 (such as an end of the shaft of the retaining element 134) and tracks a rotational position of the retaining element shaft relative to the potentiometer 152 to determine the position of the output element and the cover panel relative to the vehicle. For example, the potentiometer 152 may include an electrical trace at the PCB 146 and an electrical wiper may be disposed at the retaining element 134 so that movement of the wiper along the trace is tracked via electrical signals to determine the position of the output element 120 relative to the PCB 146.

Thus, the actuator is operable to open and close powered charge port doors for electric vehicles. The actuator includes a clutch to protect the actuator from damage due to manual or abusive movement of the door. Optionally, the clutch includes a wrap spring that slides around a shaft at one end and slides within a bore at the other end, maintaining consistent release torque in both directions. Optionally, the clutch includes a detent with an axial spring bias load. The actuator includes a position detection system that can be used by a related ECU in the vehicle to determine the door position. Optionally, the position detection system includes a two axis hall sensor positioned next to a magnet mounted to the output shaft. The sensor uses the magnet to determine the angular position of the shaft. Optionally, the position detection system uses a potentiometer that is coupled to the output shaft to determine the position of the shaft.

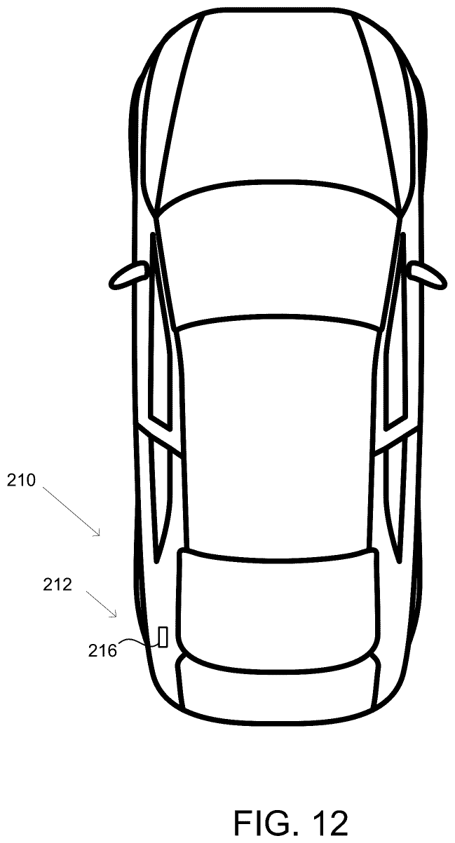

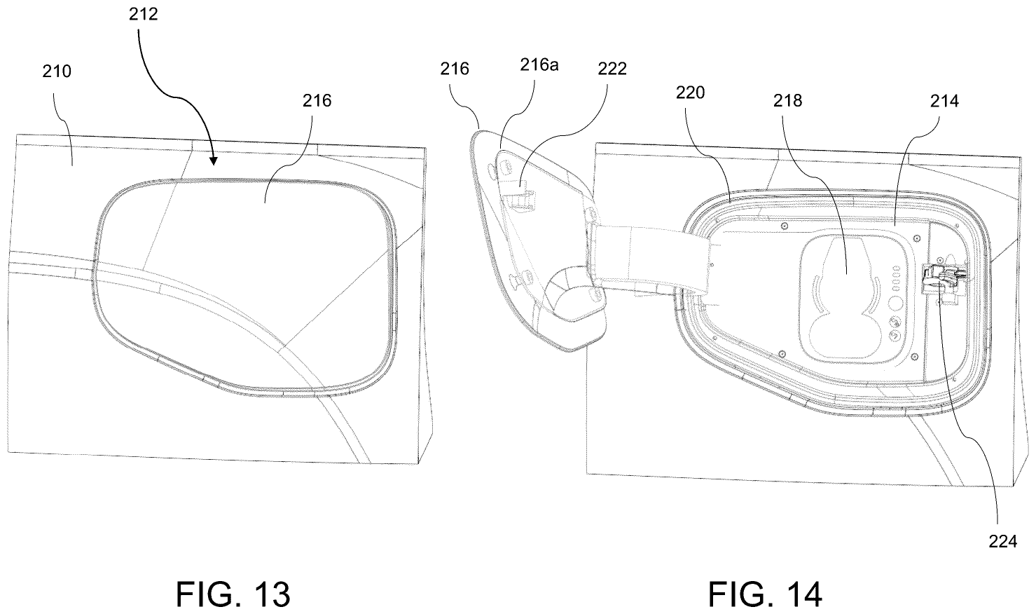

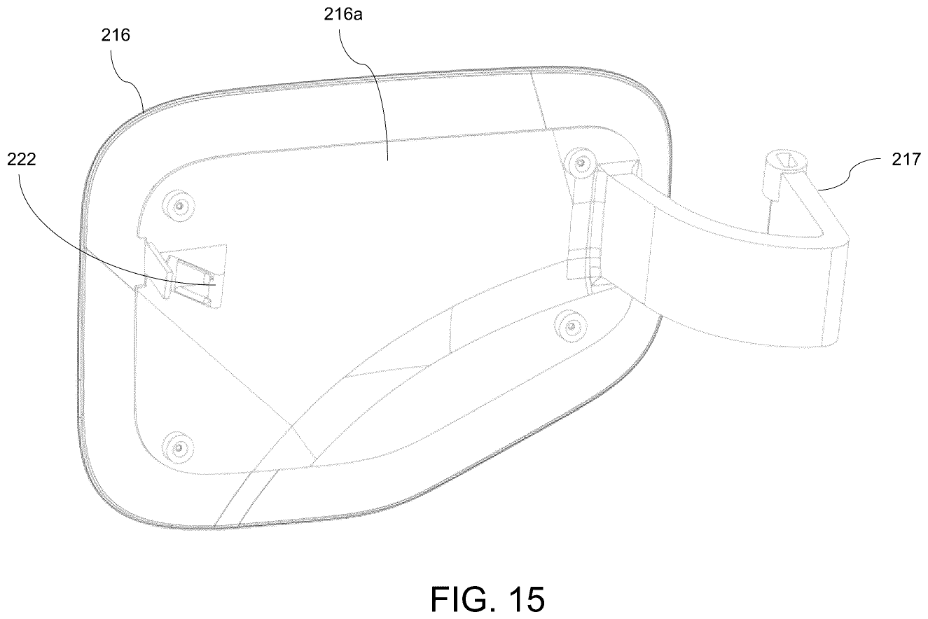

Optionally, the charge port actuator is operable to move the cover panel between the closed position and the opened state and to engage a locking mechanism for securing the cover panel in the closed position. For example, a vehicle 210 (e.g., an electric vehicle or EV, or a plug-in hybrid vehicle or PHEV) includes an electrical charging system or charge port 212 that includes a base portion or bracket 214 and a cover panel or flap 216 (FIGS. 12-14). For example, the panel 216 is pivotably mounted at the vehicle or the base portion 14 and has an outer surface that, when the panel 216 is in a closed position, corresponds with and/or is substantially flush with an outer surface of the exterior panel(s) of the vehicle 210 at and around the charge port 212 of the vehicle (e.g., FIG. 13). When in the closed position, the cover panel 216 conceals a charging connector 218 of the charge port 212 that is configured or operable to electrically connect with an electrical connector or charging wand (not shown) of a charging station or system to charge batteries of the vehicle 210. When in an open position, the cover panel 216 moves relative to the base portion 214 and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector (e.g., FIG. 14).

As shown in FIG. 12, the charge port 212 may be disposed along a side of the vehicle 210 (such as at a rear driver side portion of the vehicle) and, when the cover panel 216 is in the closed position, the exterior surface of the panel 216 is substantially flush with and corresponds to the exterior surface of the vehicle 210 and/or the base portion 214 at or surrounding the charge port 212. The charge port 212 may be disposed at any suitable position at the exterior of the vehicle. For example, the charge port 212 may be disposed at the front or rear fender or bumper of the vehicle. Optionally, the charge port 212 may be concealed behind an exterior feature of the vehicle 210, such as a manufacturers emblem, a portion of a headlight or taillight, a license plate bracket, or the like, where the closure system enables movement of the exterior feature between the closed and opened positions.

When the cover panel 216 is in the closed position, the cover panel 216 may at least partially compress a sealing element or gasket 220 between a rear or interior side 216a or an edge region of the cover panel 216 and the base portion 214 or side of the vehicle surrounding the charge port 218 to protect the connector portion 218 and limit or preclude moisture and contaminants from entering the charge port 212 when the cover panel 216 is closed (FIG. 14). For example, the sealing element 220 may be disposed at the interior side 216a of the cover panel 216 or at the base portion 214 and configured to at least partially circumscribe the connector 218 when the cover panel 216 is closed.

When the cover panel 216 is in the closed position (FIG. 13), a locking detail or element or catch 222 that extends from the rear side 216a of the cover panel 216 may receive or be engaged and releasably retained by a hook 224 disposed at the base portion 214 for locking the cover panel 216 in the closed position (FIGS. 14 and 15). That is, with the cover panel 216 in the closed position and the catch 222 disposed at or near the base portion 214, the hook 224 may capture or otherwise engage the catch 222 to secure the cover panel 216 in the closed position.

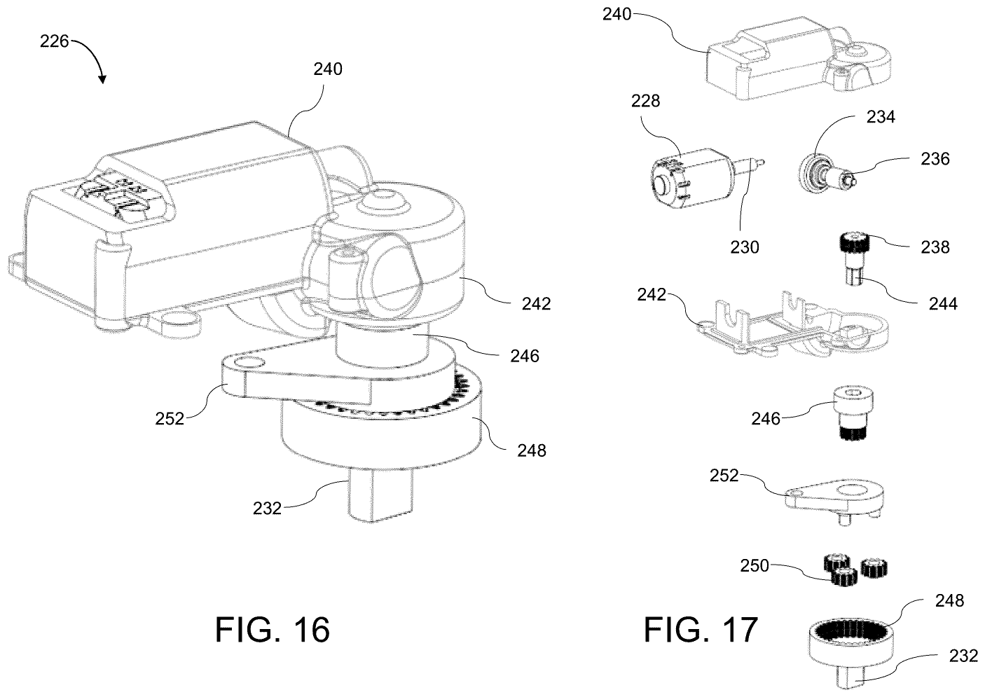

The cover panel 216 is movable between the closed position and the opened position via operation of an electrically operable actuator 226 (FIG. 16), which may be electrically operated to move the cover panel in response to a user input. For example, the actuator may deploy the cover panel 216 in response to a user input at a key fob associated with the vehicle, a button or sensor at the exterior surface of the charge port 212 or vehicle, or a button at the interior of the vehicle cabin. When actuated, the actuator (such as an electrically operable motor of the actuator) operates to move the cover panel from the closed position to the opened position, and the cover panel may move relative to the base portion or vehicle in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication No. US-2023-0191926 and/or U.S. patent application Ser. No. 18/476,632, filed Sep. 28, 2023 (Attorney Docket DON10 P4918), Ser. No. 18/419,751, filed Jan. 23, 2024 (Attorney Docket DON09 P5045), and/or Ser. No. 18/443,744, filed Feb. 16, 2024 (Attorney Docket DON10 P5080), and/or U.S. provisional application Ser. No. 63/497,457, filed Apr. 21, 2023, which are hereby incorporated herein by reference in their entireties.

Referring to FIGS. 16 and 17, the actuator 226 includes an electrically operable motor 228 that, when the actuator is operated, rotatably drives a worm gear element 230 coupled to a drive shaft of the motor 228, which in turn drives a gear train of the actuator 226 to impart movement of an output element 232 coupled to the cover panel 216. The output element 232 may be rotatably coupled to and/or keyed to the cover panel 216 (such as to a pivot arm 217 of the cover panel 216) so that, when the actuator 226 drives the output element 232, the output element 232 rotates or pivots relative to the actuator 226 about an axis of rotation of the actuator 226 and the cover panel 216 moves between the closed position and the opened position according to movement of the output element 232.

In the illustrated example of FIGS. 16 and 17, the worm gear 230 engages and drives a helical gear element 234. The helical gear 234 is coupled to an output worm 236 that engages and drives an output gear 238 of the gear train. The gear train (e.g., the motor 228, the helical gear 234 and worm gear 236, and output gear 238) is accommodated between an upper housing 240 and a lower housing 242 of the actuator 226, and the housing is configured to attach to the base portion 214 to mount the actuator 226 at the charge port 212 of the vehicle.

The output gear 238 includes or is coupled to a drive shaft portion 244 that extends from the actuator housing and along the axis of rotation and that is rotatably coupled to and drives a sun gear or central gear 246. The sun gear 246 rotates about the axis of rotation of the actuator 226. The output element 232 includes or is rotatably coupled to a ring gear portion 248 that includes an inner cylindrical tooth or gear surface. A plurality of planet or outer gears 250 (such as two gears, three gears, four or more gears, and the like) are disposed within the ring gear 248 and surround the sun gear 246. Thus, the sun gear 246 is concentric with the ring gear 248 and the planet gears 250 are disposed about the sun gear 246 and between the sun gear 246 and the ring gear 248.

A planet gear carrier or lock output element 252 is coupled to the plurality of planet gears 250 and configured to rotate or pivot about the axis of rotation of the actuator 226 according to movement of the planet gears 250 about the sun gear 246 and ring gear 248. The sun gear 246 passes through an aperture or passageway or through hole of the planet gear carrier and is not directly coupled to the planet gear carrier, such that the planet gear carrier and the sun gear 246 may rotate relative to one another. The planet gear carrier 252 includes a plurality of protrusions or pins or engagement elements that each engage a respective planet gear 250 (e.g., at a central portion of the planet gear and along an axis of rotation of the respective planet gears) so that, as the planet gears 250 are driven by the sun gear 246 and collectively travel along the ring gear 248 and about the axis of rotation of the actuator 226, the planet gear carrier 252 is pivoted about the axis of rotation of the actuator 226.

As shown in FIGS. 16 and 17, the sun gear 246 extends through the aperture or through hole in the planet gear carrier 252 to engage the planet gears 250. Thus, the sun gear 246, planet gear carrier 252, the ring gear portion 248, and the output element 232 all rotate or pivot about the axis of rotation of the actuator 226.

When the sun gear 246 is rotatably driven by the actuator 226, the planet gears 250 are rotatably driven by the sun gear 246 and may travel about the sun gear 246 to rotate or pivot the planet gear carrier 252. The planet gears 250 may travel about the sun gear 246 when rotation of the ring gear 248 is constrained and may rotate and travel with the rotation of the ring gear 246 when rotation of the ring gear is not constrained. As the planet gears 250 rotate, and if the rotation of the planet gears 250 about the sun gear 246 is constrained and the rotation of the ring gear 248 is not constrained, the planet gears 250 engage and drive the ring gear 248 so that the ring gear 248 may rotate about the axis of rotation of the actuator 226. As the ring gear 248 and output element 232 rotate, the cover panel 216 is moved between the closed position and the opened position. The planet gear carrier 252 is pivoted to drive a locking mechanism of the charge port 212.

As described further below, when the sun gear 246 is rotatably driven by the actuator 226 and based on a position of the cover panel 216 relative to the base portion 214 and/or a state of the locking mechanism, either the ring gear 248 rotates about the axis of rotation to move the cover panel 216 between the opened and closed positions or, with the cover panel in the closed position, the planet gears 250 collectively rotate about the axis of rotation to pivot the planet gear carrier 252 and drive the locking mechanism between a locked state and an unlocked state.

Thus, the planetary gear system splits the actuator torque between the pivot axis of the door and the output 252 which drives the locking mechanism. In other words, the torque generated by the actuator 226 (from the electrically operable motor 228) is applied to the output element 232 to move the door between the closed position and the opened position and the torque is applied to the planet gear carrier 252 to drive the locking mechanism to lock the cover panel 216 at the closed position.

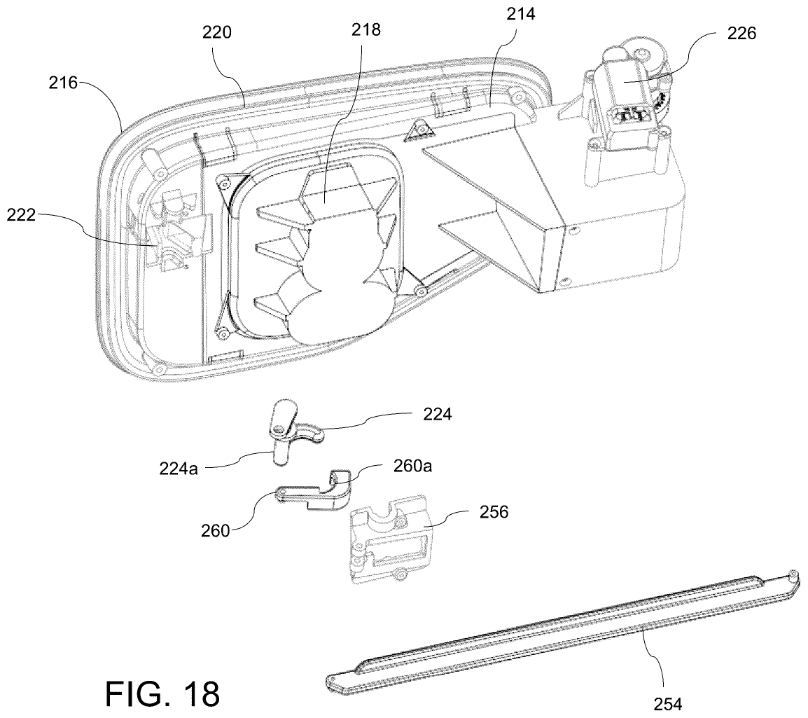

Referring to FIGS. 18-20B, the planet gear carrier 252 is coupled to a first end of an actuating link 254 of the locking mechanism and the opposite second end of the actuating link 254 is coupled to the lock hook 224. The lock hook 224 is pivotably mounted to a lock retainer or bracket 256 that is mounted to the base portion 214 at an aperture or recess of the base portion 214 that is configured to receive the catch 222 when the cover panel 216 is at or near the closed position. When the cover panel 216 is between the opened position and the closed position, the locking mechanism is in an unlocked state and pivoting of the planet gear carrier 252 is constrained via the actuating link 254. Thus, with the cover panel 216 between the opened state and the closed state, operation of the actuator 226 rotates the ring gear 248 about the axis of rotation and moves the cover panel 216 between the opened state and the closed state.

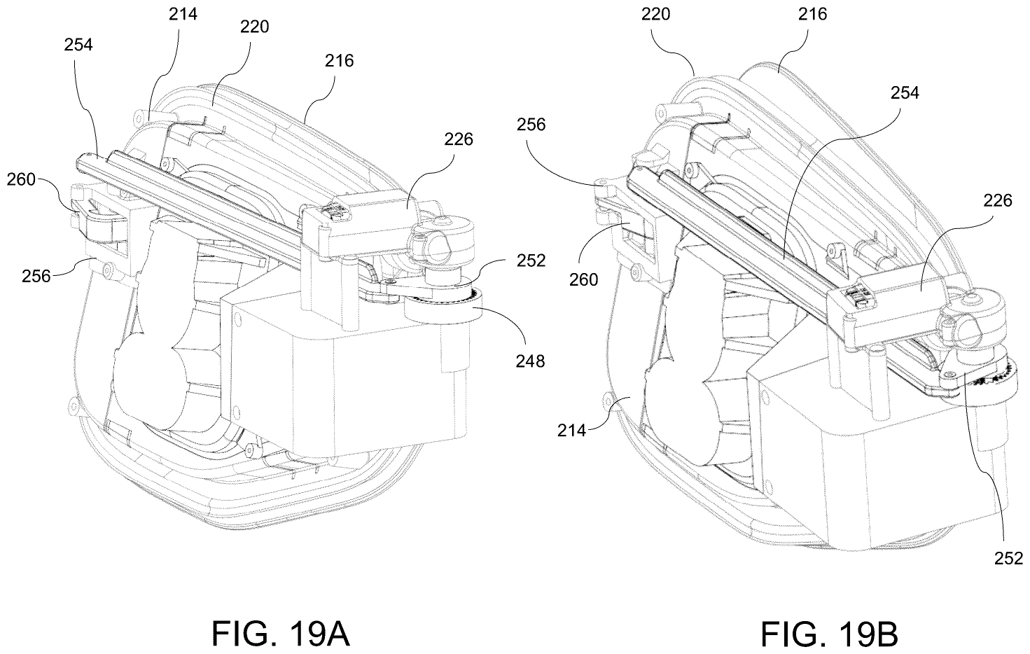

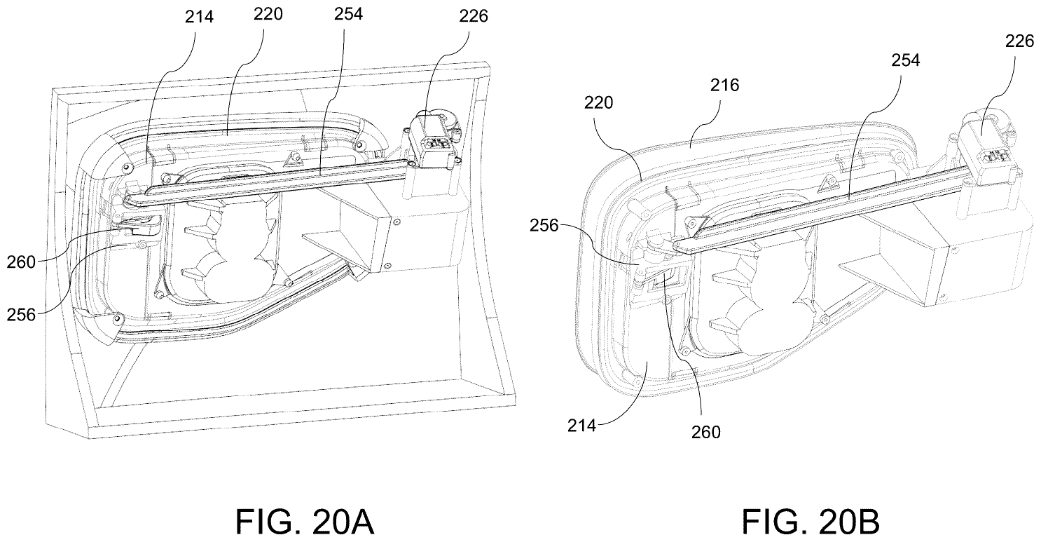

When the cover panel 216 pivots from the opened position to the closed position and is in the closed position with the catch 222 received at the base portion 214, rotation of the ring gear 248 in a direction that would move the cover panel toward the closed position is constrained via the cover panel 216 engaging the base portion 214 and/or sealing element 220, and pivoting of the planet gear carrier 252 is not constrained. Thus, with the catch 222 received through the aperture of the base portion 214 and when the actuator 226 is operated to move the cover panel toward the closed position, the planet gear carrier 252 is pivoted in a first direction (e.g., clockwise in FIG. 19A) to move the actuating link 254 in a first linear direction (e.g., left in FIG. 20A) to pivot the hook 224 into engagement with the catch 222 and lock the cover panel 216. That is, with the hook 224 engaged with the catch 222, the locking mechanism of the actuator 226 is in a locked state and the cover panel 216 cannot be manually moved from the closed position.

When the cover panel 216 is in the closed position and the hook 224 is received at the catch 222, rotation of the ring gear 248 is constrained when the actuator 226 is operated to move the cover panel toward the opened position. Thus, with the locking mechanism in the locked state, operation of the actuator 226 to move the cover panel 216 toward the opened position drives the planet gears 250 about the sun gear 246 and the planet gear carrier 252 is pivoted to move the actuating link 254 and release the hook 224 from the catch 222. That is, to unlock the cover panel 216, the planet gear carrier 252 is pivoted in an opposite second direction (e.g., counterclockwise in FIG. 19B) to move the actuating link 254 in an opposite second linear direction (e.g., right in FIG. 20B) to pivot the hook 224 out of engagement with the catch 222 of the cover panel 216. When the hook 224 is not engaged with the catch 222, the locking mechanism of the actuator 226 is in an unlocked state and the hook 224 is received or engaged by a lock pawl 260. The lock pawl 260 retains the hook 224 to constrain the planet gear carrier 252 via the hook 224 and actuating link 254 so that the cover panel 216 may be moved between the closed position and the opened position, such as manually moved or moved via further electrical operation of the actuator 226.

Optionally, when the actuating link 254 pivots the hook 224 to engage the catch 222 and lock the cover panel 216, the hook 224 pulls in or draws in the cover panel 216 toward the base portion 214. Thus, the actuator 226, via the hook 224, may apply a retaining force at the cover panel 216, such as to at least partially compress the sealing element 220 between the base portion 214 and the cover panel 216.

Optionally, when the hook 224 is pivoted from the locked position (e.g., FIGS. 19A and 20A) toward the unlocked position (e.g., FIGS. 19B and 20B), the hook 224 (such as a protrusion extending from the hook, or a curved portion of the hook) engages the cover panel 216 and urges the cover panel 216 toward the opened position. Thus, the actuator 226, via the hook 224, applies a force at the cover panel 216, such as to separate the cover panel 216 from the sealing element 220 and/or break through or loosen ice buildup at the exterior surface of the cover panel 216. With the cover panel 216 unlocked and moved partially toward the opened position, movement of the cover panel 216 fully to the opened position may apply less strain on the actuator 226.

In other words, the lock hook 224 engages the locking detail 222 on the door 216 when the hook 224 is rotated or pivoted inward (e.g., clockwise in FIG. 18) by the actuating link 254. When the door 216 is unlocked, the actuating link 254 rotates or pivots the lock hook 224 to disengage the locking detail 222 on the door 216. The unlocking action also helps push the door 216 toward the opened position, such as if the door 216 is frozen and there is ice buildup at the exterior surface of the door 216 and/or to decompress or release the seal.

Thus, FIG. 19A shows the planet gear carrier 252 rotated or pivoted to the clockwise position, with the locking mechanism locked (i.e., the hook 224 is engaging the catch 222) and the lock pawl 260 may be moved out of engagement with the hook 224. FIG. 19B shows the planet gear carrier 252 rotated or pivoted to the counterclockwise position and the locking mechanism unlocked (i.e., the hook 224 is not engaging the catch 222) and the lock pawl 260 engaging the hook 224, with the door 216 at least partially moved toward the opened position.

The lock pawl 260 is pivotably mounted to the lock retainer 256 and is configured to hold the lock hook 224 away from the aperture in the base portion 214 and/or the catch 222 when the catch 222 is away from the base portion 214 (e.g., the cover panel is in the opened position) or otherwise out of range to be engaged by the lock hook 224. When the hook 224 is pivoted out of engagement with the catch 222, the pawl 260 pivots toward the hook 224 and engages the hook 224 to prevent the hook 224 from pivoting back toward the catch 222. For example, a recess or receiving portion or hook 260a of the pawl 260 may engage a catch or stem 224a of the lock hook 224 to prevent the lock hook 224 from pivoting relative to the lock retainer 256 (FIG. 18). A biasing element, such as a torsion spring or other suitable biasing element, may bias the pawl 260 toward engagement with the lock hook 224.

In other words, the lock pawl 260 holds the lock hook 224 open whenever the door 216 is open too far for the lock hook 224 to engage the door 216. This prevents the lock hook 224 from closing prematurely while the door 216 is being closed by the actuator 226. The lock pawl 260 may be biased in rotation toward the catch 224a in the lock hook 224 by a biasing element, such as a torsion spring (not shown).

Further, when the lock pawl 260 is engaged with the lock hook 224, movement of the actuating link 254 and thus rotation of the planet gear carrier 252 is constrained. Thus, when the locking mechanism is moved to the unlocked state and the lock hook 224 is moved out of engagement with the catch 222 and the lock pawl 260 moves into engagement with the lock hook 224, further operation of the actuator 226 rotates the ring gear 248 and moves the cover panel from the closed position toward the opened position. When the cover panel 216 is moved to the closed position, the catch 222 engages the pawl 260 to move the pawl 260 out of engagement with the lock hook 224 and thus allow the planet gear carrier 252 to pivot when the cover panel 216 engages the base portion and constrains the ring gear 248.

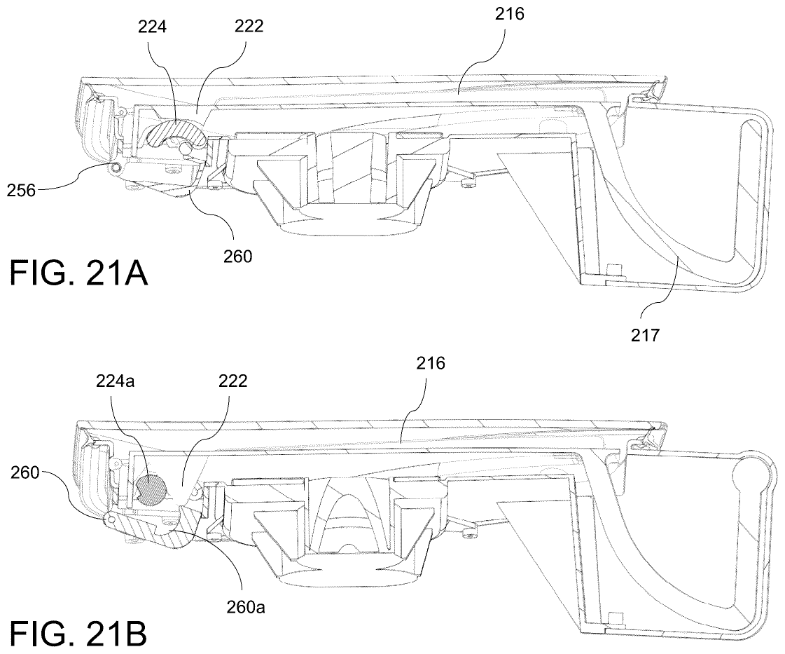

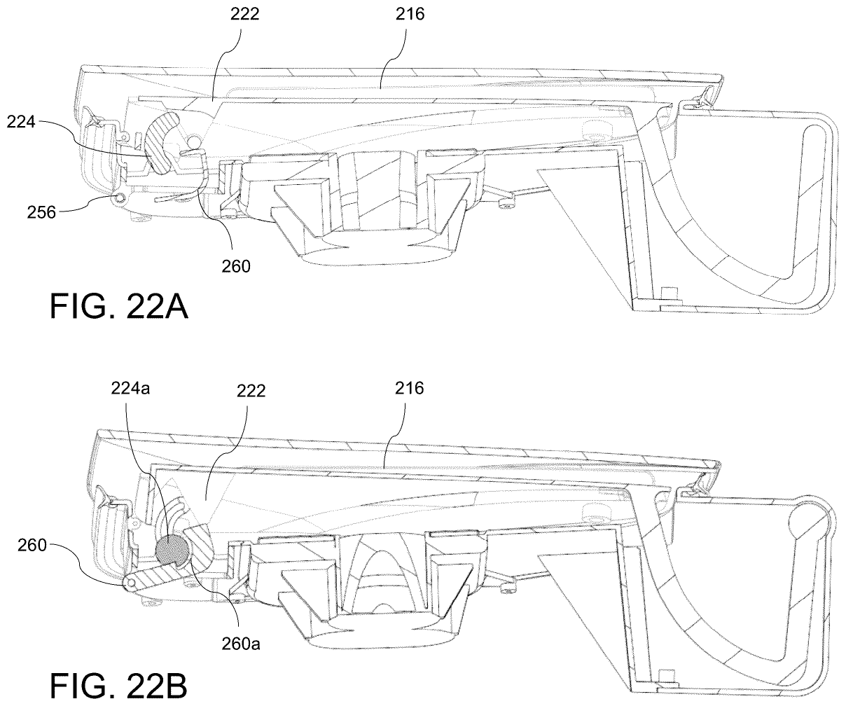

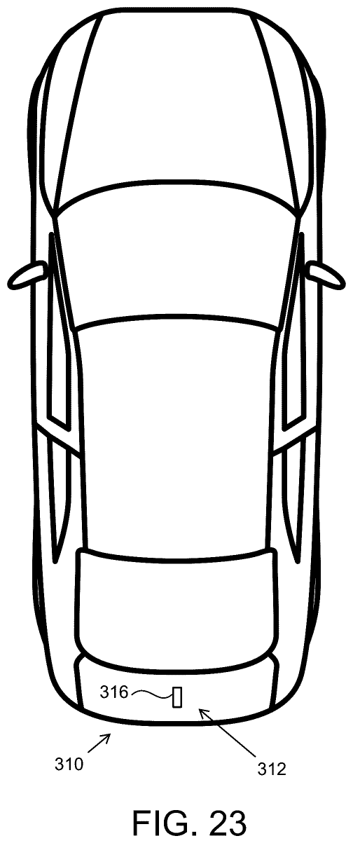

As shown in FIGS. 21A-22B, when the cover panel 216 is in the closed position and the locking mechanism is in the locked state, the hook 224 is engaged with the catch 222 (FIG. 21A) and the catch 222 engages the pawl 260 to prevent the pawl 260 from pivoting into engagement with the hook 224. Thus, FIG. 21A shows the lock hook 224 engaged with the locking detail 222 on the door 216 and FIG. 21B shows the lock detail 222 on the door 216 pushing on the pawl 260 to keep the pawl 260 disengaged from the notch 224a in the lock hook 224.

When the locking mechanism is moved to the unlocked state, the actuator 226 moves the actuating link 254 to move the hook 224 out of engagement with the catch 222 (FIG. 22A), and the protrusion 258 on the hook 224 may engage the cover panel 216 and urge the cover panel toward the opened position as the hook 224 moves relative to the catch 222. With the hook 224 moved out of engagement with the catch 222 and the cover panel 216 moved at least partially toward the opened position, the catch 222 moves out of engagement with the pawl 260 and the pawl is biased into engagement with the hook 224 to prevent the hook 224 from moving back toward engagement with the catch 222 (FIG. 22B).

Thus, FIG. 22A shows the lock hook 224 rotated or pivoted to be disengaged from the lock detail 222 on the door 216. FIG. 22B shows that, with the door 216 partially opened, the lock pawl 260 is allowed to rotate or pivot toward the lock hook 224, engaging the notch 224a in the lock hook 224. With the pawl 260 engaged with the lock hook 224, the pawl 260 prevents the lock hook 224 from rotating or pivoting into a locked position, provided the door 216 is open far enough to prevent engagement (i.e., the door is moved out of engagement with the pawl). Upon closing of the door 216, the door lock detail 222 will press on the pawl 260, disengaging the pawl 260 from the lock hook 224 and allowing the lock hook 224 to rotate or pivot and engage the door 216 to lock it in place.

Typically, an actuator designed to open and/or close the charge port door that is driven at the pivot axis of the charge port door provides insufficient torque to break through ice build-up at the charge port door when moving the door from the closed position and the actuator provides insufficient torque to compress the door seal when moving the charge port door to the closed position. Commonly, a secondary mechanism is needed to push the door open when frozen and to tightly seal and lock the door when not in use. The actuator 226 avoids the need for a second actuator and applies a separating force to break through ice build-up at the cover panel 216 and applies a retaining force to compress the sealing element 220 when closing the cover panel 216, while also providing a locking mechanism to secure the cover panel in the closed position.

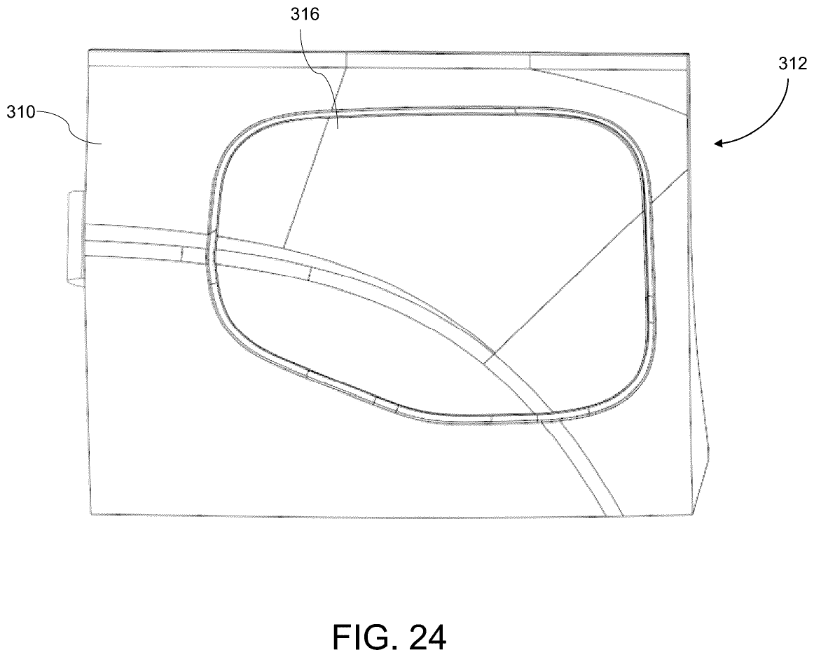

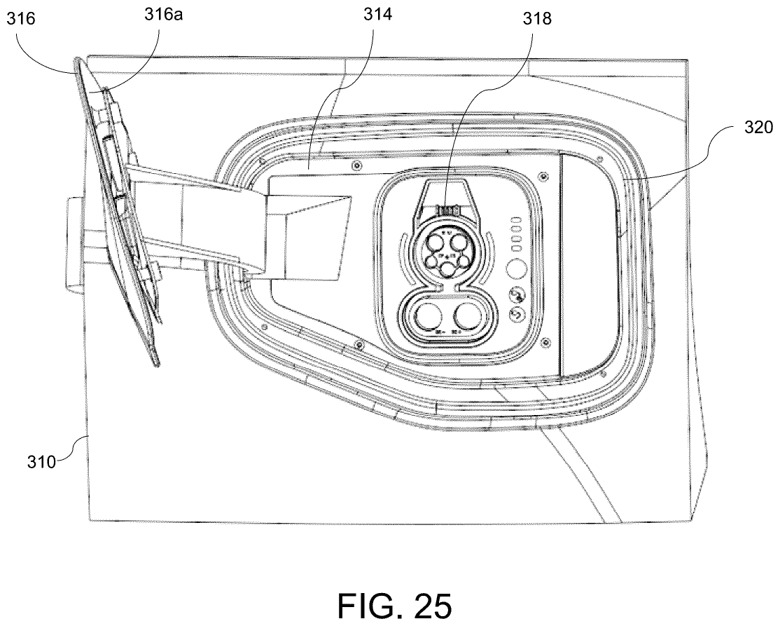

Optionally, the charge port system includes an actuator having a mechanical linkage that is configured to provide higher torque when driving the cover panel at or near the closed position (such as to cinch the cover panel in the closed position and/or break through ice buildup or other resistance when moving the cover panel from the closed position toward the opened position), and that is configured to provide higher speed when driving the cover panel at or near the opened position (such as to provide more rapid movement of the cover panel when the cover panel is likely to be free from resistance). For example, a vehicle 310 (e.g., an electric vehicle or EV, or a plug-in hybrid vehicle or PHEV) includes an electrical charging system or charge port 312 that includes a base portion or bracket 314 and a cover panel or flap 316 (FIGS. 23-25). For example, the panel 316 is pivotably mounted at the vehicle or the base portion 314 and has an outer surface that, when the panel 316 is in a closed position, corresponds with and/or is substantially flush with an outer surface of the exterior panel(s) of the vehicle 310 at and around the charge port 312 of the vehicle (e.g., FIG. 24). When in the closed position, the cover panel 316 conceals a charging connector 318 of the charge port 312 that is configured or operable to electrically connect with an electrical connector or charging wand (not shown) of a charging station or system to charge batteries of the vehicle 310. When in an open position, the cover panel 316 moves relative to the base portion 314 and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector (e.g., FIG. 25).

As shown in FIG. 23, the charge port 312 may be disposed at a rear portion of the vehicle 310 (or at a side portion or other portion of the vehicle) and, when the cover panel 316 is in the closed position, the exterior surface of the panel 316 is substantially flush with and corresponds to the exterior surface of the vehicle 310 and/or the base portion 314 at or surrounding the charge port 312. The charge port 312 may be disposed at any suitable position at the exterior of the vehicle. For example, the charge port 312 may be disposed at the front or rear fender or bumper of the vehicle. Optionally, the charge port 312 may be concealed behind an exterior feature of the vehicle 310, such as a manufacturers emblem, a portion of a headlight or taillight, a license plate bracket, or the like, where the closure system enables movement of the exterior feature between the closed and opened positions.

When the cover panel 316 is in the closed position, the cover panel 316 may at least partially compress a sealing element or gasket 320 between a rear or interior side or an edge region of the cover panel 316 and the base portion 314 or body panel of the vehicle surrounding the charge port 318 to protect the connector portion 318 and limit or preclude moisture and contaminants from entering the charge port 312 when the cover panel 316 is closed (FIGS. 24 and 25). For example, the sealing element 320 may be disposed at the interior side of the cover panel 316 or at the base portion 314 and configured to at least partially circumscribe the connector 318 when the cover panel 316 is closed.

The cover panel 316 is movable between the closed position and the opened position via operation of an electrically operable actuator, which may be electrically operated to move the cover panel in response to a user input. For example, the actuator may deploy the cover panel 316 in response to a user input at a key fob associated with the vehicle, a button or sensor at the exterior surface of the charge port 312 or vehicle, or a button at the interior of the vehicle cabin. When actuated, the actuator (such as an electrically operable motor of the actuator) operates to move the cover panel from the closed position toward the opened position, and the cover panel may move relative to the base portion or vehicle in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication No. US-2023-0191926 and/or U.S. patent application Ser. No. 18/476,632, filed Sep. 28, 2023 (Attorney Docket DON10 P4918), Ser. No. 18/419,751, filed Jan. 23, 2024 (Attorney Docket DON09 P5045), and/or Ser. No. 18/443,744, filed Feb. 16, 2024 (Attorney Docket DON10 P5080), and/or U.S. provisional application Ser. No. 63/497,457, filed Apr. 21, 2023, which are hereby incorporated herein by reference in their entireties.

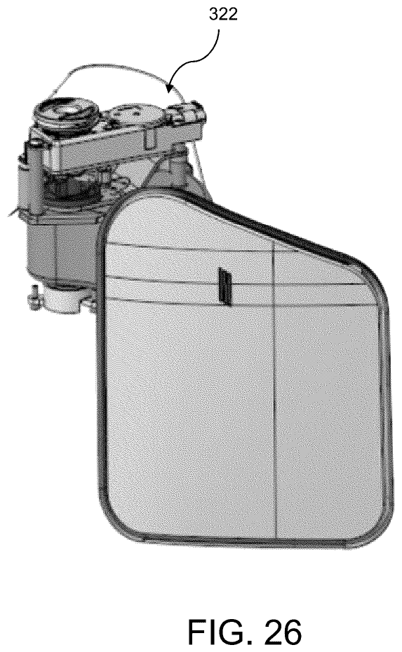

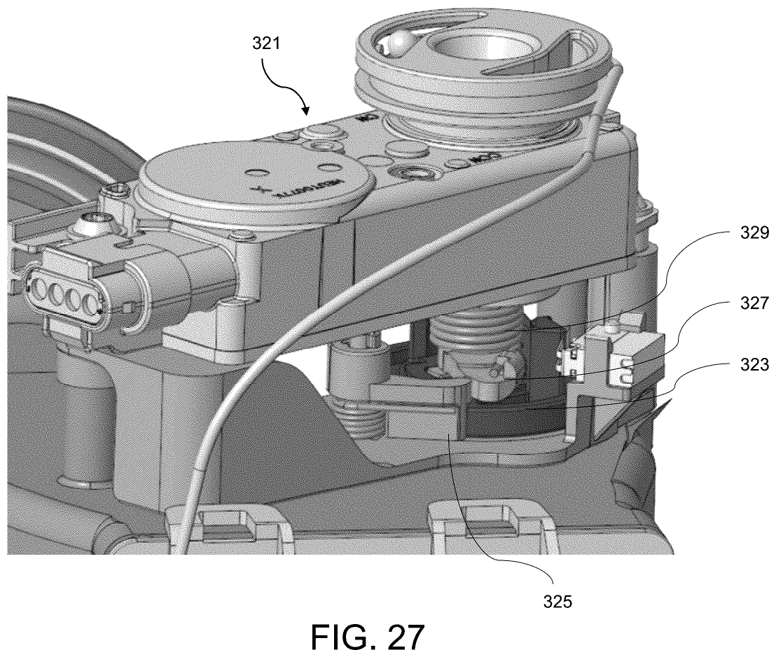

As shown in FIGS. 26 and 27, an actuator 321 that is electrically operated to open and close the charge port cover panel is coupled to a drive shaft that rotates to move the cover panel between the opened position and the closed position. When the cover panel is in the closed position, the actuator 321 precludes movement of the drive shaft to retain the cover panel in the closed position. Because the actuator 321 directly drives the drive shaft (e.g., the drive shaft is directly coupled to an output shaft of the actuator and/or is rotated about an output axis of the actuator when driven by the actuator), the holding torque of the actuator 321 may not be sufficient to hold the door against the sealing element, and a secondary latch may hold the door against the sealing element in the closed position. The actuator 321 includes a latch mechanism that, when engaged, precludes movement of the drive shaft. The latch mechanism includes a lock cam 323 that engages a lock pawl 325. A lock release cam 327 is biased away from engagement with the lock pawl 325 by a biasing element 329, such as a torsion spring. With the lock cam 323 engaged with the lock pawl 325, movement of the drive shaft and thus movement of the cover panel from the closed position is resisted, and when the lock release cam 327 engages the lock pawl 325, the lock pawl 325 is moved out of engagement with the lock cam 323 and the cover panel may move between the closed position and the opened position.

When the drive shaft of the actuator is directly driven by the actuator and/or rotatably driven by the actuator in line with or along the output axis of rotation of the actuator, the output torque of the actuator may not be sufficient to close the cover panel door tightly against the seal, and the output torque may not be sufficient to overcome resistance at the closed cover panel (such as to break ice) by directly driving the door pivot. Further, the release of the latch or lock cam may result in sudden movement of the door when opening, which could result in collisions between the door and objects in the environment or other damage to the cover panel. Moreover, the proximity of the actuator and clutch to the door pivot creates a difficult packaging problem.

In other words, high torque is preferred to actuate a charge port door in the closed position to compress the seal and to open the door against obstructions like ice. Further, rapid opening of the door is desired to avoid wait times for the user when opening the door to charge the vehicle.

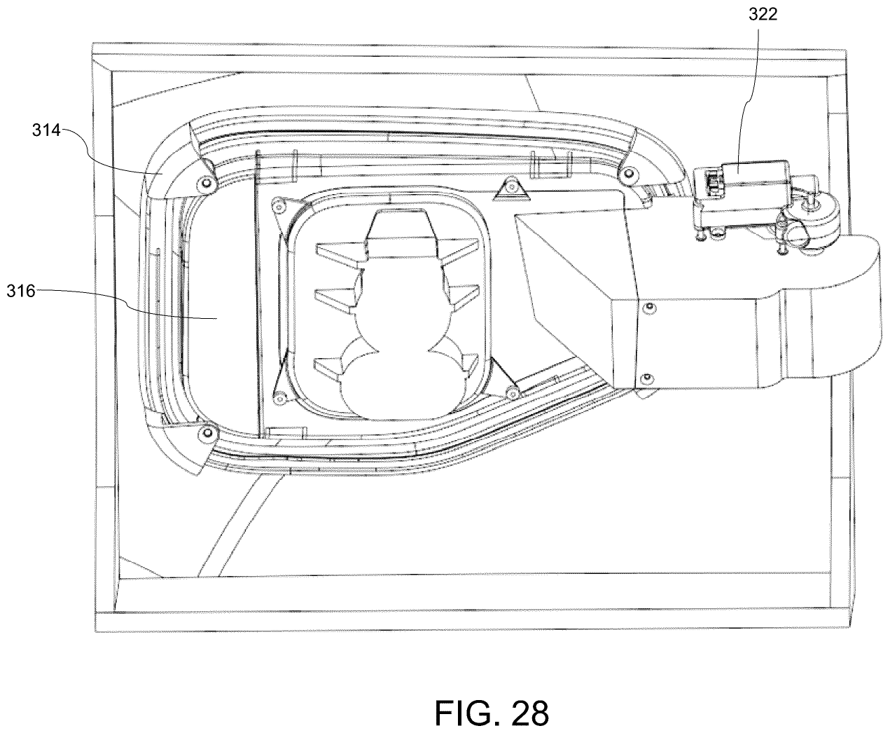

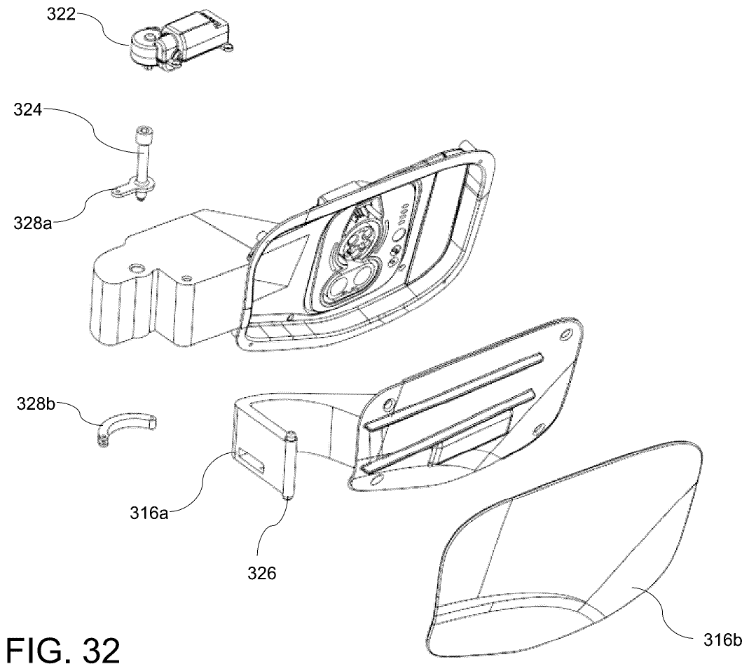

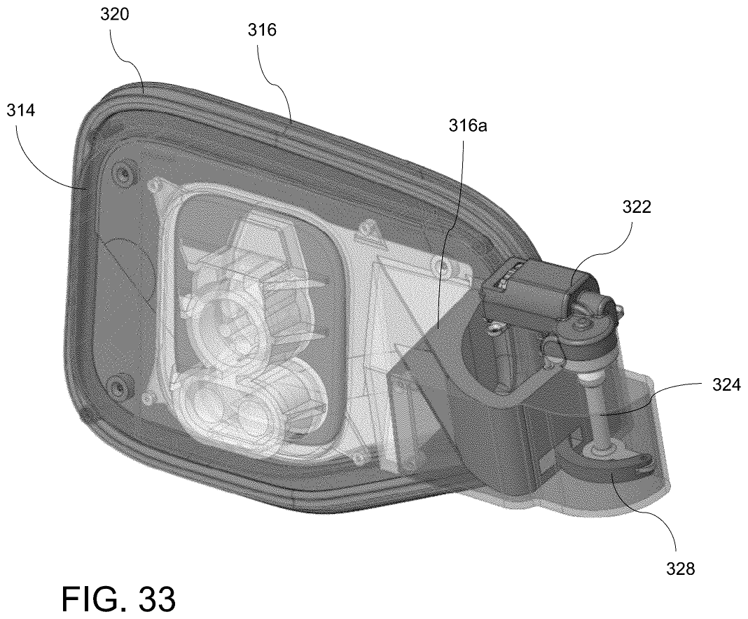

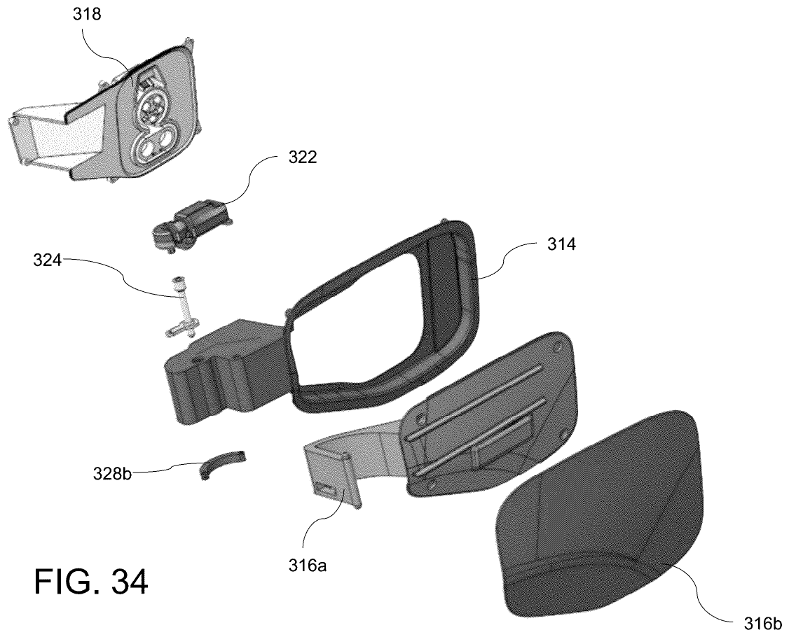

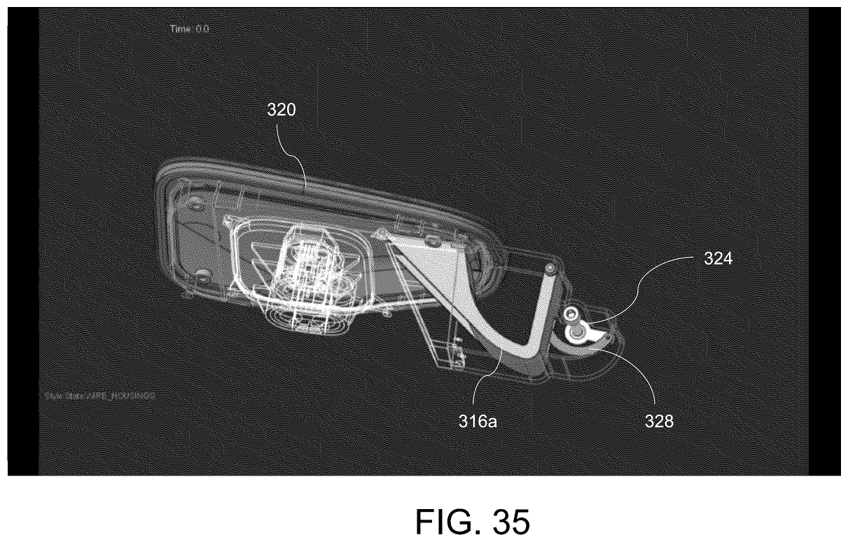

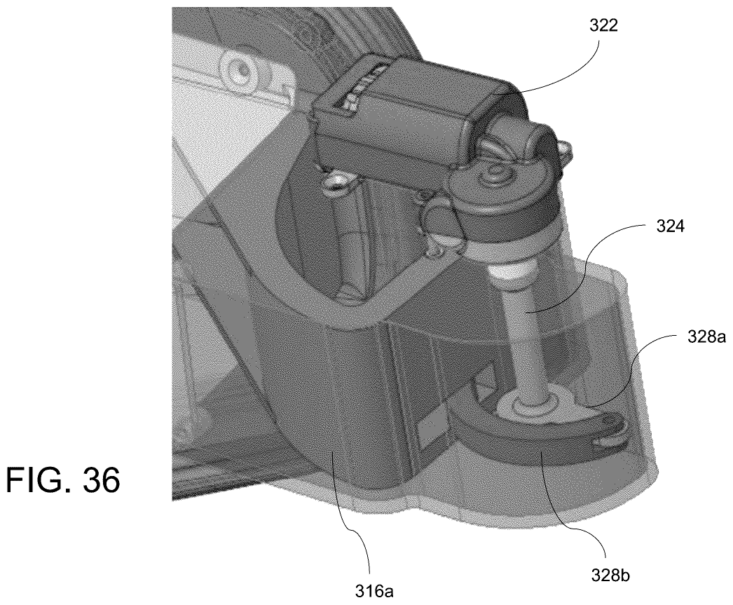

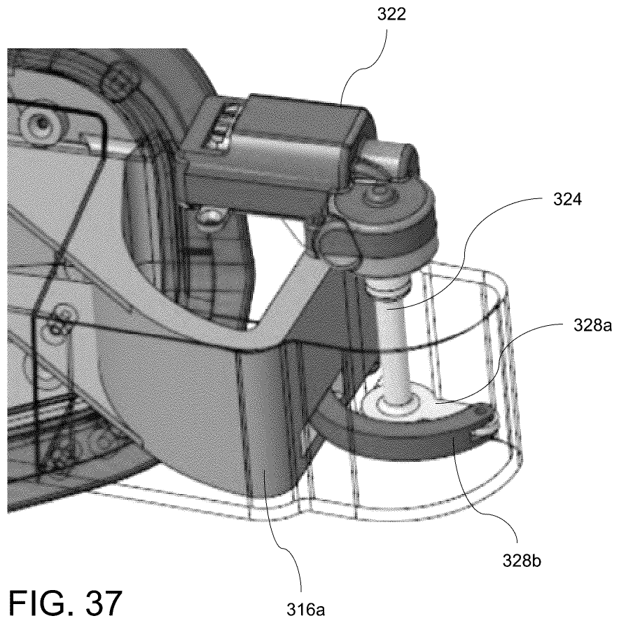

Referring to FIGS. 28-37, an actuator 322 is disposed at the base portion 314 and is electrically operable to move the cover panel 316 between the closed position and the opened position relative to the base portion 314. The actuator 322 includes a motor that, when electrically operated, rotatably drives a drive shaft or output shaft 324 that is coupled to the actuator 322. For example, the electrically operable motor may drive a gear train mechanically coupled between the motor and the drive shaft 324 to rotate the drive shaft 324 about an axis of rotation of the actuator 322. In other words, the drive shaft 324 rotates or pivots about the axis of rotation of the actuator that extends along a longitudinal axis of the drive shaft 324.

The cover panel 316 is pivotally disposed at the base portion 314 and pivots about a pivot axis of the cover panel 316 that is offset from the axis of rotation of the actuator 322 and parallel to the axis of rotation of the actuator 322. For example, the cover panel 316 includes a pivot arm or hinge arm portion 316a that pivots about a pivot pin 326 disposed at the base portion 314 and remote or spaced from the drive shaft 324. The hinge arm portion 316a may be coupled to an outer panel portion 316b to form the cover panel 316.

A pivot link or lock link 328 connects the drive shaft 324 and the cover panel 316 so that, when the drive shaft 324 is rotatably driven by the actuator 322, the cover panel 316 moves between the closed position and the opened position according to movement of the drive shaft 324. In other words, operation of the actuator 322 imparts movement of the cover panel 316 by driving the drive shaft 324 and via the connection between the drive shaft 324 and lock link 328. The lock link 328 includes a first portion or driving portion 328a and a second portion or curved linking portion 328b. The first portion or driving portion 328a of the lock link 328 is fixed relative to the drive shaft 324 and extends radially from the drive shaft 324 at an end of the drive shaft 324 that is opposite the actuator 322. Thus, when the drive shaft 324 rotates, an end of the driving portion 328a moves with the drive shaft 324 and pivots about the axis of rotation of the actuator 322. A clutch element may be disposed along the drive shaft 324 between the actuator 322 and the first portion 328a of the lock link 328.

The second portion or curved linking portion 328b of the lock link 328 includes a first end that is pivotally connected to the driving portion 328a and an opposite second end of the curved linking portion 328b is pivotally connected to the hinge arm 316a of the cover panel 316. Thus, the first end of the linking portion 328b moves about the axis of rotation of the actuator 322 according to movement of the driving portion 328a and the second end of the linking portion 328b moves about the axis of rotation of the cover panel 316 according to movement of the hinge arm 316a when the cover panel 316 is moved between the closed position and the opened position. The second portion 328b of the lock link 328 is curved and pivotally connected to the first portion 328a and the hinge arm 336a to accommodate the different pivot axes of the actuator and cover panel. The curved second portion may move along a swinging arcuate path of motion when the cover panel is moved between the closed position and the opened position. For example, when the cover panel is in the closed position, the curved second portion 328b may be generally concentric with the drive shaft 324 and when the cover panel is in the opened position, the curved second portion 328b may be generally concentric with the pivot pin 326 of the cover panel 316.

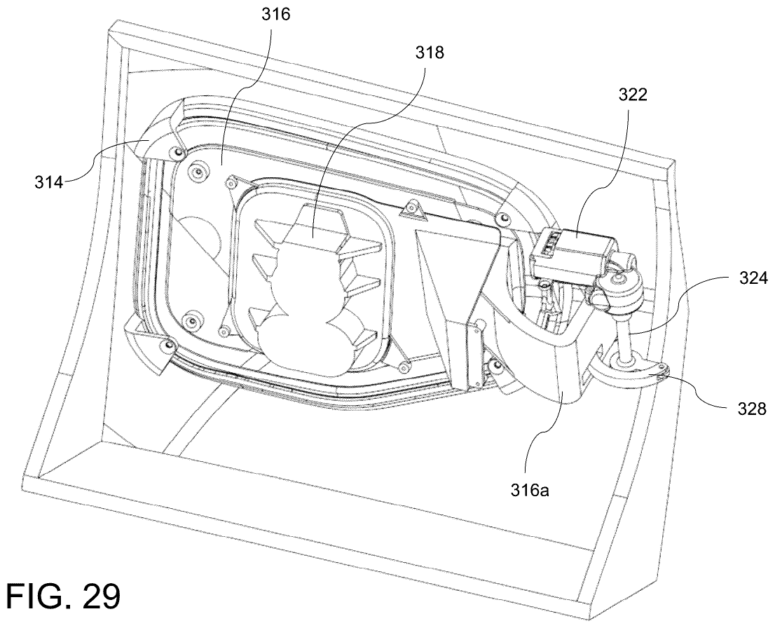

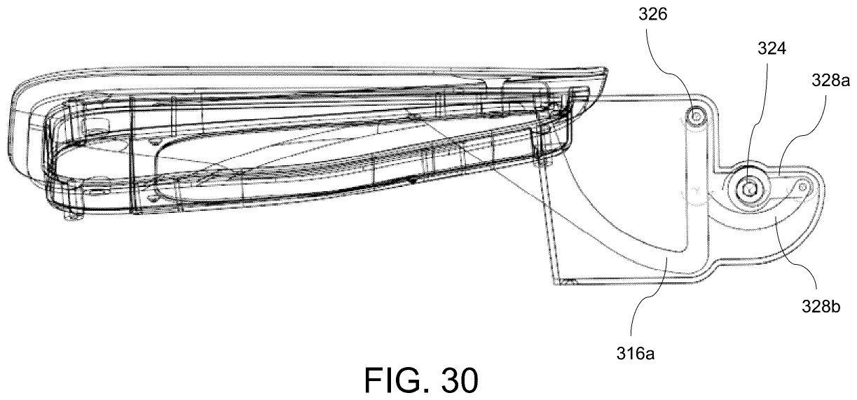

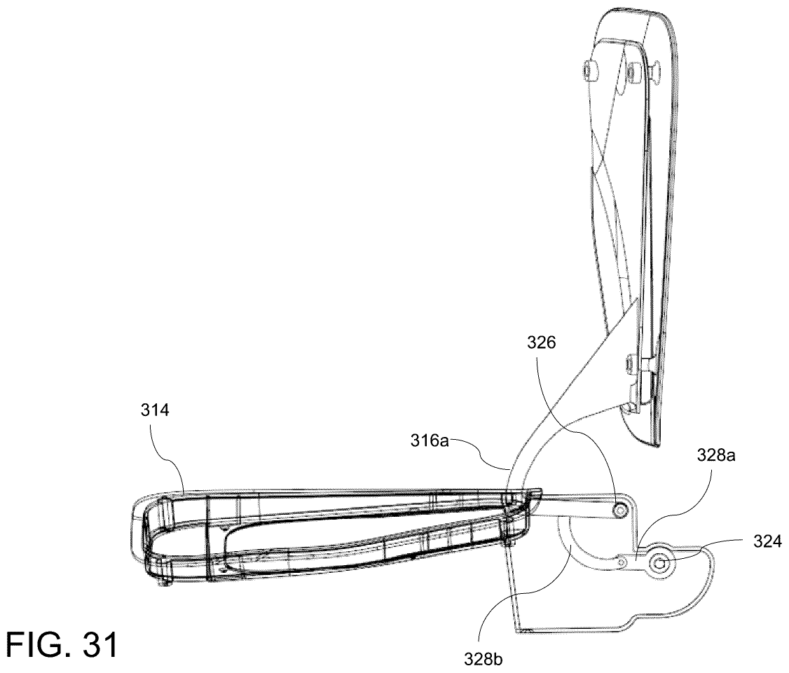

When the cover panel 316 is in the closed position (e.g., FIGS. 29 and 30), the driving portion 328a extends from the drive shaft 324 in a first direction away from the hinge arm 316a (e.g., right in FIG. 30) and the linking portion 328b extends between the hinge arm 316a and the driving portion 328a and curves around the drive shaft 324. Thus, in the closed position, a pivot axis of the lock link 328 may be aligned with the pivot axis of the actuator 322 (i.e., the drive shaft 324). As the drive shaft 324 is driven to move the cover panel 316 toward the opened position (e.g., FIG. 31), the driving portion 328a pivots in a first direction about the axis of rotation of the actuator 322 (e.g., clockwise in FIG. 30), the hinge arm 316a pivots in the first direction about the axis of rotation of the cover panel 316 (i.e., the pivot pin 326) and the linking portion 328b pivots relative to the driving portion 328a and the hinge arm 316a to accommodate the offset axes of rotation. Thus, as the cover panel 316 moves toward the opened position, the pivot axis of the lock link 328 may move out of alignment with the axis of rotation of the actuator 322, such as to increase the radius between the end of the linking portion 328b connected to the hinge arm 316a and the drive shaft 324.

Because of the lock link 328, the actuator 322 provides higher torque output at the cover panel 316 when the cover panel 316 is at or near the closed position (e.g., for compressing the sealing element 320 when closing the charge port or overcoming resistance from the closed position due to ice when opening the charge port) and the actuator 322 provides more rapid movement of the cover panel as the cover panel moves toward the opened position. For example, the ratio between rotational speed of the drive shaft 324 and rotational speed of the cover panel 316 may approach one-to-one as the cover panel 316 moves toward the opened position. Further, as the cover panel 316 moves to the closed position (e.g., FIG. 30) and the driving portion 328a pivots about the drive shaft 324 (e.g., counterclockwise in FIG. 31), the linking portion 328b is pulled by the driving portion 328a and may cinch about the drive shaft 324 to apply a closing force at the cover panel 316.

In other words, when the door or cover panel is closed, the link pivot 328b moves over the center of the drive shaft 324. This results in a high closing force with relatively little torque needed from the actuator 322. The resulting mechanical advantage also provides very high force available for braking ice when the door or cover panel begins opening. Once the door or cover panel is at least partially open, the speed ratio between the drive shaft 324 and the door or cover panel 316 may approach one to one. Simply put, the actuator uses a drive link to change the relative rotational speed between the actuator shaft and the door hinge over the range of the door motion, providing increased effective torque on the door when the door is in the closed position.

Thus, the actuator 322 and lock link 328 provides increased drive torque when the door is closed to improve door seal compression and to reduce the torque requirement on the actuator to maintain door closure. That is, the lock link 328 may reduce or eliminate the need for actuator holding torque to keep the cover panel 316 in the closed position. Increased drive torque when the door is first opening may help overcome obstructions such as ice buildup. The actuator may thus have improved seal force and ice breaking force at the cover panel door. In other words, the lock link provides maximum leverage at the closed position, which results in a mechanical advantage for the actuator when the door is closing and opening to maximize torque at the end of the path of travel of the lock link (i.e., at or near the closed position) while maintaining rapid average actuation speed.

Further, the actuator provides added torque when opening the cover panel without the need for multiple gear ratios and avoids the added cost and packaging challenges of a larger and/or faster actuator with similar torque outputs. Increased drive speed ratio while the door is opening may reduce the time it takes for the actuator to open the door and allows for smooth operation and easy movement of the door when open, with minimal added cost. Moreover, because the lock link 328 may be positioned at the end of the drive shaft 324 distal from the actuator 322, there is improved space for packaging of a clutch member along the drive shaft 324 for actuator protection.

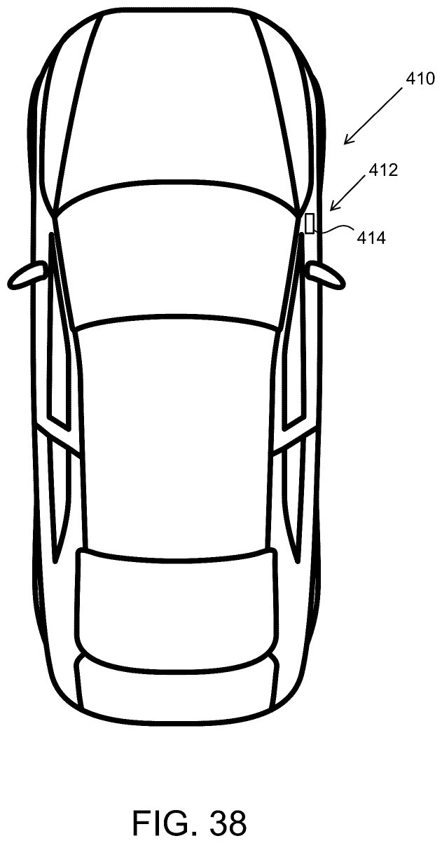

Optionally, the charge port system includes an actuator having variable gear ratios configured to provide higher torque and lower speed when driving the cover panel at or near the closed position (such as to cinch the cover panel in the closed position and/or break through ice buildup or other resistance when moving the cover panel from the closed position toward the opened position, and that is configured to provide higher speed and lower torque when driving the cover panel at or near the opened position (such as to provide more rapid movement of the cover panel when the cover panel is likely to be free from resistance). For example, and referring now to FIG. 38, a vehicle 410 (e.g., an electric vehicle or EV, or a plug-in hybrid vehicle or PHEV) includes an electrical charging system or charge port 412 that includes a base portion or bracket (not shown) and a cover panel or flap 414. For example, the panel 414 is pivotably mounted at the vehicle or the base portion and has an outer surface that, when the panel 414 is in a closed position, corresponds with and/or is substantially flush with an outer surface of the exterior panel(s) of the vehicle 410 at and around the charge port 412 of the vehicle. When in the closed position, the cover panel 414 conceals a charging connector (not shown) of the charge port 412 that is configured or operable to electrically connect with an electrical connector or charging wand (not shown) of a charging station or system to charge batteries of the vehicle 410. When in an open position, the cover panel 414 moves relative to the base portion and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector.

As shown in FIG. 38, the charge port 412 may be disposed along a side of the vehicle 410 (such as at a front passenger side portion of the vehicle or elsewhere at a side portion or rear portion or front portion of the vehicle) and, when the cover panel 414 is in the closed position, the exterior surface of the panel 414 is substantially flush with and corresponds to the exterior surface of the vehicle 410 and/or the base portion at or surrounding the charge port 412. The charge port 412 may be disposed at any suitable position at the exterior of the vehicle. For example, the charge port 412 may be disposed at the front or rear fender or bumper of the vehicle. Optionally, the charge port 412 may be concealed behind an exterior feature of the vehicle 410, such as a manufacturers emblem, a portion of a headlight or taillight, a license plate bracket, or the like, where the closure system enables movement of the exterior feature between the closed and opened positions.

When the cover panel 414 is in the closed position, the cover panel 414 may at least partially compress a sealing element or gasket between a rear or interior side or an edge region of the cover panel 414 and the base portion or side of the vehicle surrounding the charge port to protect the charging connector and limit or preclude moisture and contaminants from entering the charge port 412 when the cover panel 414 is closed. For example, the sealing element may be disposed at the interior side of the cover panel 414 or at the base portion and configured to at least partially circumscribe the connector when the cover panel 414 is closed.

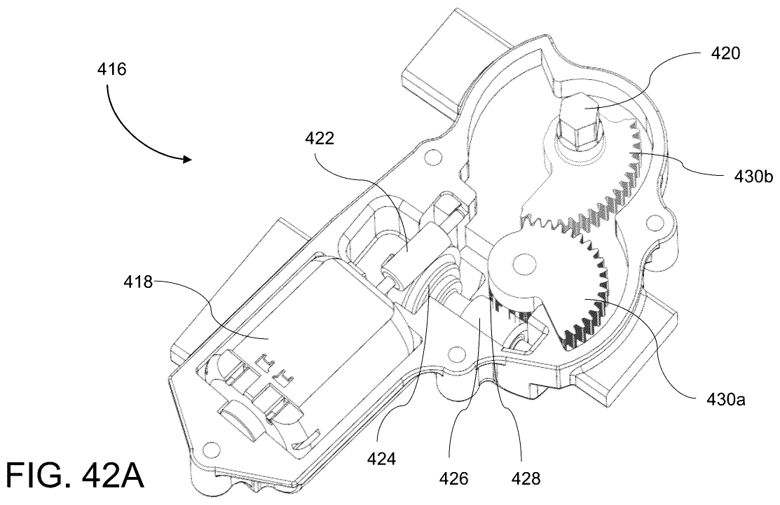

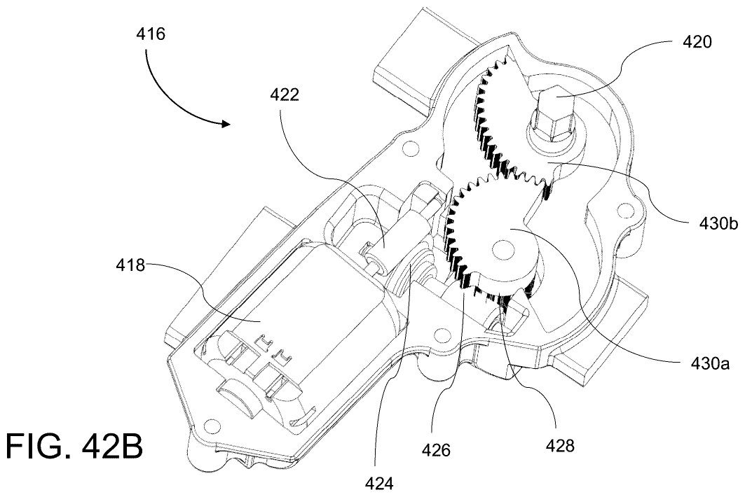

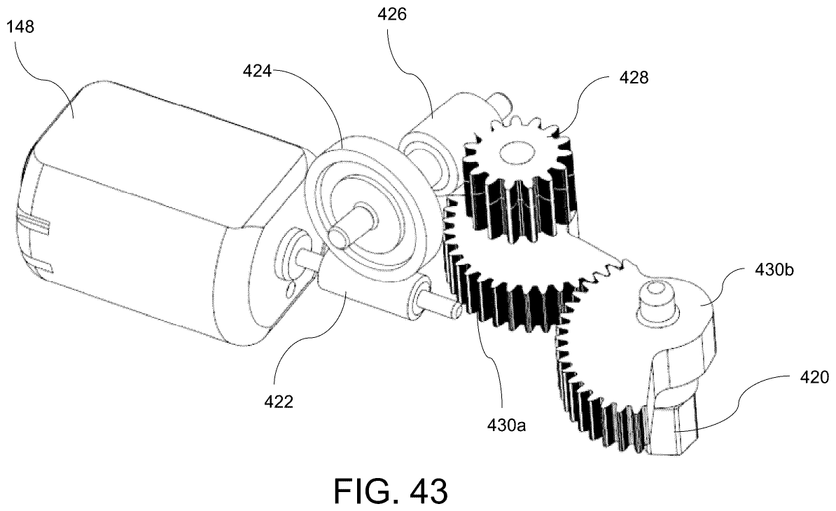

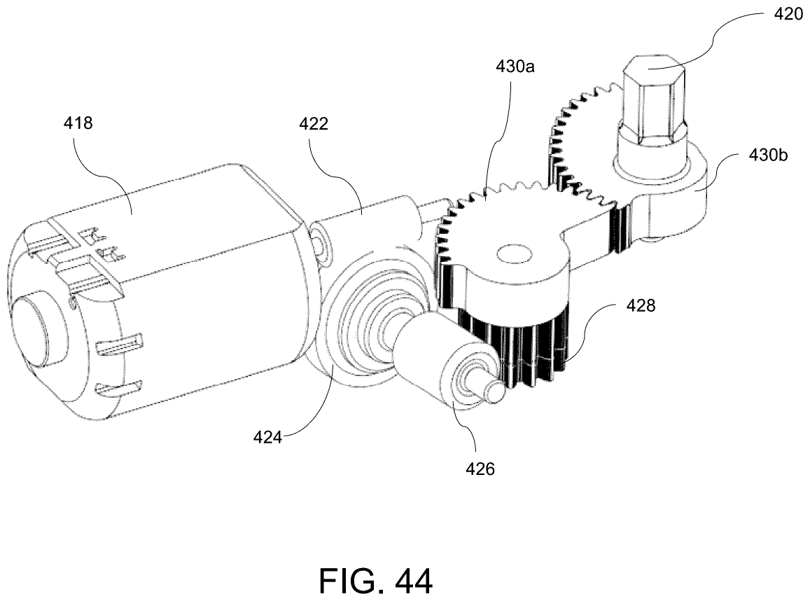

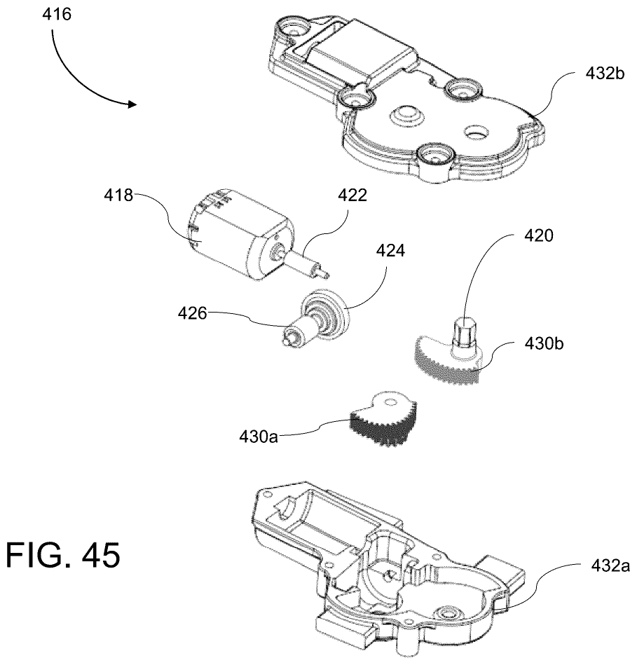

The cover panel 414 is movable between the closed position and the opened position via operation of an electrically operable actuator 416 (FIGS. 42A-45), which may be electrically operated to move the cover panel in response to a user input. For example, the actuator may deploy the cover panel 414 in response to a user input at a key fob associated with the vehicle, a button or sensor at the exterior surface of the charge port 412 or vehicle, or a button at the interior of the vehicle cabin. When actuated, the actuator (such as an electrically operable motor of the actuator) operates to move the cover panel from the closed position toward the opened position, and the cover panel may move relative to the base portion or vehicle in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication No. US-2023-0191926 and/or U.S. patent application Ser. No. 18/476,632, filed Sep. 28, 2023 (Attorney Docket DON10 P4918), Ser. No. 18/419,751, filed Jan. 23, 2024 (Attorney Docket DON09 P5045), and/or Ser. No. 18/443,744, filed Feb. 16, 2024 (Attorney Docket DON10 P5080), and/or U.S. provisional application Ser. No. 63/497,457, filed Apr. 21, 2023, which are hereby incorporated herein by reference in their entireties.

An actuator with high torque output is preferred to actuate a charge port door in the closed position to compress the seal and to open the door against obstructions like ice buildup at the exterior surface of the cover panel. Further, rapid opening of the door is desired to avoid wait times for the user when opening the door to charge the vehicle. Typically, multiple gear ratios are used to optimize actuators for high torque and rapid movement without using an expensive motor. However, multiple gear ratios and two-speed actuators are complex and may be prone to malfunction under certain conditions.

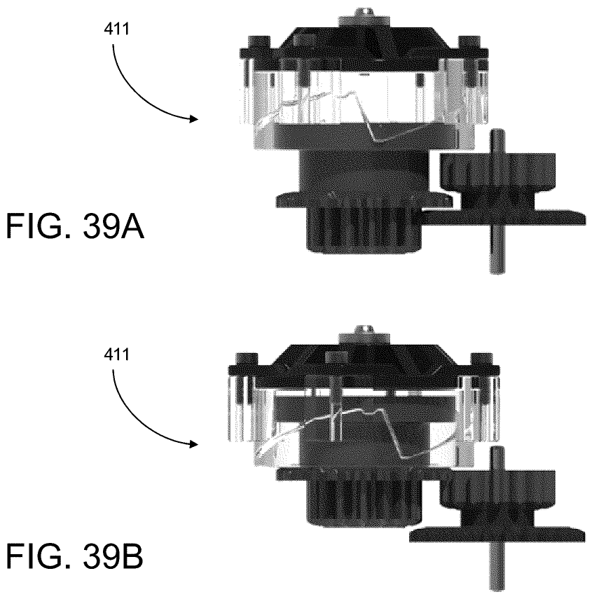

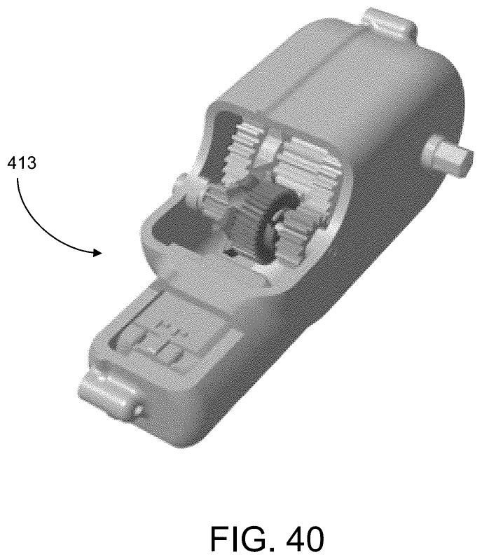

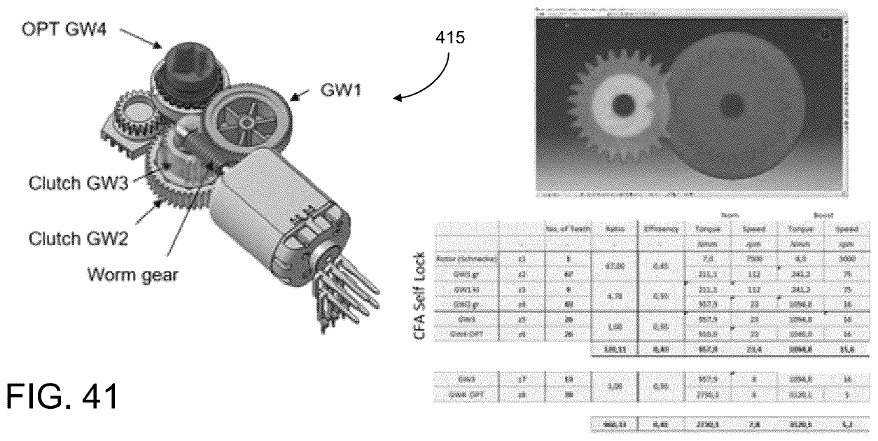

For example, with a two speed transmission coupled to an actuator, such as the transmission 411 shown in FIGS. 39A and 39B or the transmission 413 shown in FIG. 40, shifting may be unidirectional and initiated by torque load, and the transmission may be complex and difficult to package with the actuator and may risk jamming. With the two speed transmission 415 shown in FIG. 41, there may be limited tooth engagement for high torque transfer and the transmission 415 may be complex.

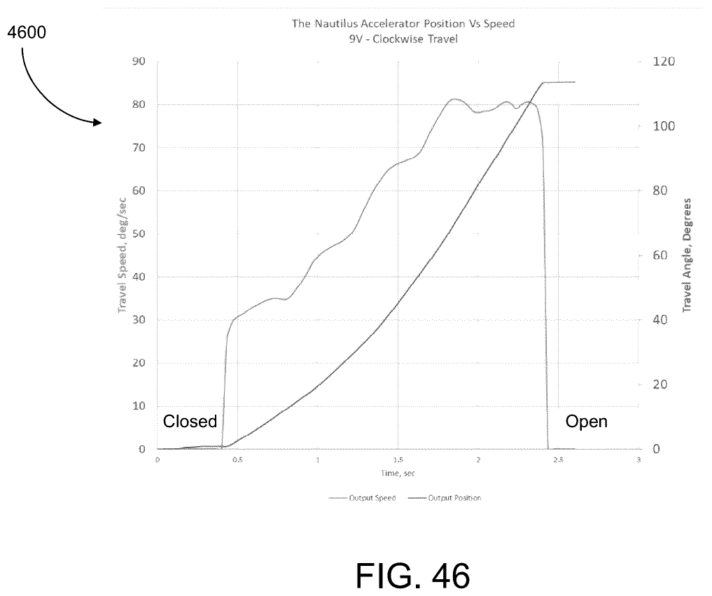

As discussed further below, the actuator 416 includes a gear train with variable output or variable ratio gears that provide higher torque output and lower speed output when the actuator 416 is being operated to move the cover panel and the cover panel is at or near the closed position and the variable ratio gears provide lower torque output and faster speed output when the actuator 416 is being operated and the cover panel is at or near the opened position. For example, the diagram 4600 of FIG. 46, shows that the actuator 416 provides a variable speed output as the actuator 416 is operated to move the cover panel 414 between the closed position and the opened position. As the cover panel 414 moves from the closed position toward the opened position, the output speed of the actuator 416 increases.

Referring to FIGS. 42A-44, the actuator 416 includes an electrically operable motor 418 that, when the actuator 416 is electrically operated to move the cover panel 414 between the closed position and the opened position, is electrically operated to impart rotation of an output element 420 of the actuator 416. When the output element 420 is rotatably driven by the motor 418, the output element 420 imparts movement of the cover panel 414 relative to the base portion and/or the side of the vehicle at which the charge port 412 is disposed. The output element 420 may be connected to the cover panel 414 such that the cover panel 414 moves between the closed position and the opened position according to rotation of the output element 420. For example, the actuator 416 may rotatably drive a helical element that engages a portion of the cover panel 414 to move the cover panel when the helical element is rotated. Optionally, the actuator 416 drives a linear output element that, when driven by the actuator 416, moves axially relative to the actuator and cover panel to move the cover panel between the closed position and the opened position.

The motor 418 drives a gear train of the actuator 416 to impart rotation of the output element 420 and variable output gears are disposed along the gear train between the motor 418 and the output element 420 to vary the torque and rotational speed provided by the output element 420 during constant motor output 418. In other words, the motor 418 provides a constant speed and constant torque output and the gear train between the motor 18 and the output element 420 is configured to convert the constant speed and constant torque output of the motor 418 to a variable or non-constant speed and non-constant torque output at the output element 420. For example, the motor 418, when electrically operated, drives a worm gear element 422 coupled to a drive shaft of the motor 418, which in turn engages and drives a helical gear 424, which in turn rotatably drives a gear 426 that rotates with the helical gear 424. The gear 426 engages and drives a spur gear 428 that is coupled to a first variable output gear or first nautilus gear 430a. The first nautilus gear 430a engages and drives a second variable output gear or second nautilus gear 430b that is rotatably coupled to the output element 420, such that the output element 420 rotates according to rotation of the second nautilus gear 430b.

The first nautilus gear 430a and the second nautilus gear 430b each have variable or changing gear ratios (i.e., variable or changing radii) such that the gear ratio between the two gears increases as the actuator pivots the gears in a first direction and decreases as the actuator pivots the gears in an opposite second direction. The respective ratios of the first nautilus gear 430a and the second nautilus gear 430b correspond to one another to provide constant gear engagement throughout the range of motion of the actuator and the cover panel. For example, when the cover panel 414 is in the closed position (e.g., FIG. 42A), a region or portion of the first nautilus gear 430a having a higher gear ratio (i.e., smaller radius) engages a region or portion of the second nautilus gear 430b having a lower gear ratio (i.e., larger radius). As the cover panel 414 moves toward the opened position (e.g., FIG. 42B), the actuator 416 drives the gear train until a region or portion of the first nautilus gear 430a having a lower gear ratio (i.e., larger radius) engages a region or portion of the second nautilus gear 430b having a higher gear ratio (i.e., smaller radius).

Thus, when the cover panel 414 is at or near the closed position, the actuator 416 provides higher torque output (such as to compress the sealing element or break through ice buildup at the outer surface of the cover panel) and lower speed output. As the cover panel 414 moves toward the opened position, the torque output may decrease and the speed of the output may increase to provide more rapid movement of the cover panel 414 toward the opened position.

The motor 418 and the gear train may be accommodated in a housing, such as between a lower actuator housing 432a and an upper actuator housing 432b. Optionally, a clutch element is disposed between the second nautilus gear 430b and the output element 420 to allow the output element 420 to slip relative to the gear train, such as to protect the motor during high torque load situations and/or to allow the cover panel to be manually moved between the closed position and the opened position. Optionally, the clutch element is integrated into the output element and/or the second nautilus gear.

In other words the actuator 416, with the cover panel 414 in the retracted or closed position may provide a maximum gear ratio and maximum output torque, such as a gear ratio between the first nautilus gear 430a and the second nautilus gear of 2.05 to 1 and a total gear ratio of the actuator gear train of 1169 to 1. At the closed position, the stall torque for a 12 volt motor may be about 3.9 Newton-meters or about 4.1 Newton-meters. For a 9 volt motor, the stall torque at the closed position may be about 3.0 Newton-meters. The actuator 416, with the cover panel 414 in the extended or opened position may provide a minimum gear ratio and maximum output speed, such as a gear ratio between the first nautilus gear 430a and the second nautilus gear of 0.64 to one and a total gear ratio of the actuator gear train of 364 to 1. At the opened position, the stall torque for the 12 volt motor may be about 1.2 Newton-meters or about 1.3 Newton-meters. For a 9 volt motor, the stall torque at the opened position may be about 1.0 Newton-meters. As the actuator moves the cover panel between the closed position and the opened position, the average actuator gear train ratio may be about 558 to 8 and the average travel speed with no load for the 12 volt motor may be about 54 degrees per second.

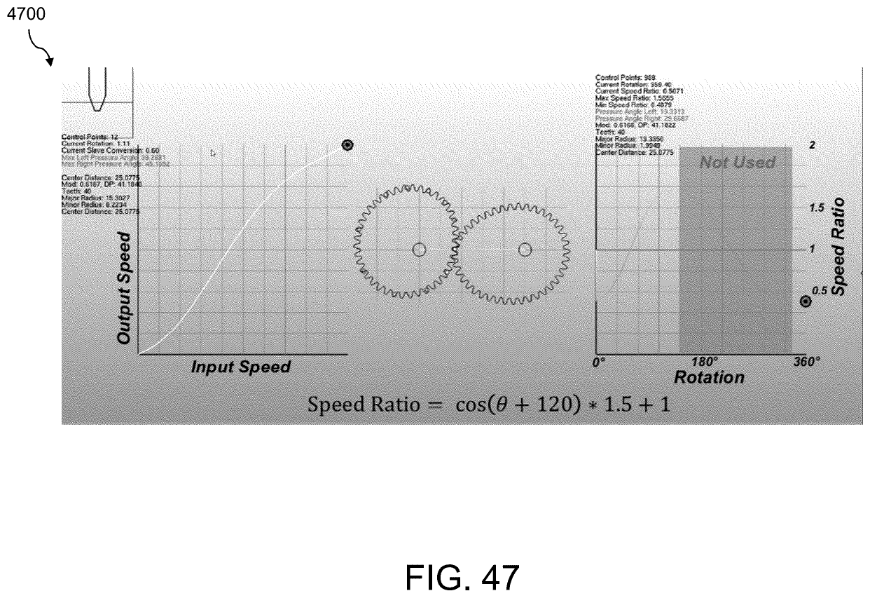

The first and second variable output gears may comprise any suitable non-circular or freeform shape. For example, and as shown in the diagram 4700 of FIG. 47, the freeform gears of the actuator may be designed with a rolling rack so that all gear teeth have the correct involute curve. Optionally, the gear train may include any suitable type of gear such as spur gears, elliptical gears, logarithmic gears, racks, hypocycloids, freeform gears, and many other mechanical specialty objects such as sprockets, ratchets and the like.

Thus, the actuator 416 provides a simple, compact design with minimal added cost (e.g., one additional gear component). The actuator provides constant gear engagement and is reliable. The ratio change (between output torque and output speed) is initiated by position of the cover panel between the closed position and the opened position rather than by, for example, a torque load at the actuator. The rotational output of the output element 420 may be limited based on the variable ratio output gears 430a, 430b, such as to 180 degrees of travel or less, 120 degrees of travel or less, 90 degrees of travel or less and the like. Thus, the actuator may preferably be used for limited range applications like charge port cover panels and fuel port cover panels.

Although described herein as operated to move a charge port cover panel between the closed position and the opened position, the actuator and variable ratio output gears may be suitable for use in any application, such as in actuators that require high torque at specific positions, such as actuators used with charge port door actuators, flush door handle actuators, power fold mirror actuators, power extend actuators, cinch actuators, and the like. The actuator provides a simple, robust, flexible, and cost-effective solution. The actuator provides unique dynamic motion for moving components. The actuator changes gear ratio based on the position of the output shaft. The actuator includes a free-form gear design which creates a nautilus-shaped profile on the gears. The actuator may maximize torque at the end of travel (e.g., as the cover panel moves to the closed position) while increasing average actuation speed. The actuator uses a variable ratio gear interface between non-circular gears.

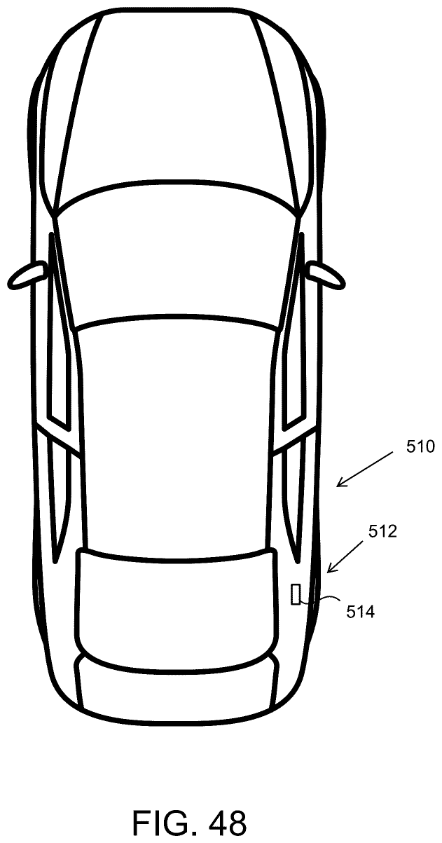

Optionally, the charge port system may include a linear or axial actuator that operates to axially move the cover panel inboard and/or outboard from the side of the vehicle and, with the cover panel moved inboard or outboard from the side of the vehicle, pivots or rotates the cover panel away from the charge port to allow access to the charging connector. For example, a vehicle 510 (e.g., an electric vehicle or EV, or a plug-in hybrid vehicle or PHEV) includes an electrical charging system or charge port 512 that includes a base portion or bracket and a cover panel or flap 514 (FIG. 48). For example, the panel 514 is movably or adjustably mounted at the vehicle or the base portion and has an outer surface that, when the panel 514 is in a closed position, corresponds with and/or is substantially flush with an outer surface of the exterior panel(s) of the vehicle 510 at and around the charge port 512 of the vehicle. When in the closed position, the cover panel 514 conceals a charging connector (not shown) of the charge port 512 that is configured or operable to electrically connect with an electrical connector or charging wand (not shown) of a charging station or system to charge batteries of the vehicle 510. When in an open position, the cover panel 514 moves relative to the base portion and away from the side of the vehicle to reveal the charging connector such that the electrical connector of the charging wand (that is electrically connected to the charging station or system and that is configured or operable for electrically connecting to or plugging into the charging connector of the vehicle) can electrically connect to the charging connector.

As shown in FIG. 47, the charge port 512 may be disposed along a side of the vehicle 510 (such as at a rear passenger side portion of the vehicle) and, when the cover panel 514 is in the closed position, the exterior surface of the panel 514 is substantially flush with and corresponds to the exterior surface of the vehicle 510 and/or the base portion at or surrounding the charge port 512. The charge port 512 may be disposed at any suitable position at the exterior of the vehicle. For example, the charge port 512 may be disposed at the front or rear fender or bumper of the vehicle. Optionally, the charge port 512 may be concealed behind an exterior feature of the vehicle 510, such as a manufacturers emblem, a portion of a headlight or taillight, a license plate bracket, or the like, where the closure system enables movement of the exterior feature between the closed and opened positions.

When the cover panel 514 is in the closed position, the cover panel 514 may at least partially compress a sealing element or gasket between a rear or interior side or an edge region of the cover panel 514 and the base portion or side of the vehicle surrounding the charge port 512 to protect the connector portion and limit or preclude moisture and contaminants from entering the charge port 512 when the cover panel 514 is closed. For example, the sealing element may be disposed at the interior side of the cover panel 514 or at the base portion and configured to at least partially circumscribe the connector when the cover panel 514 is closed.

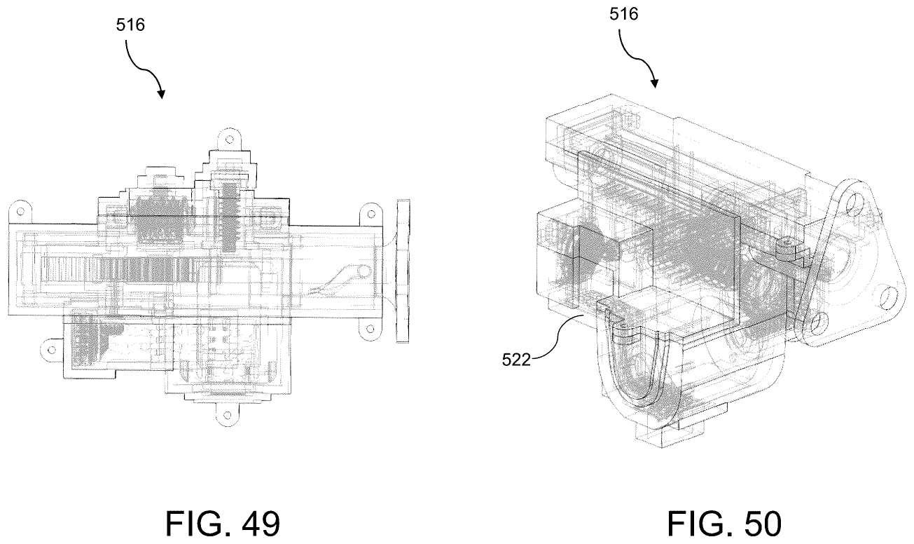

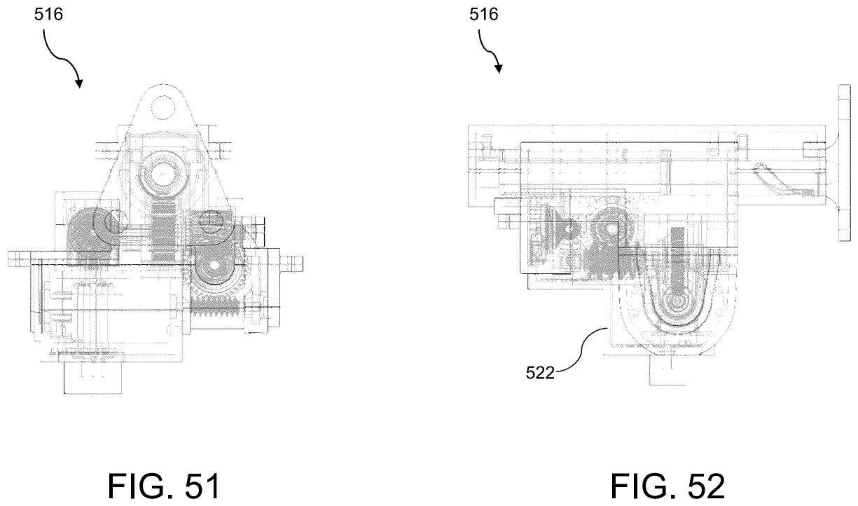

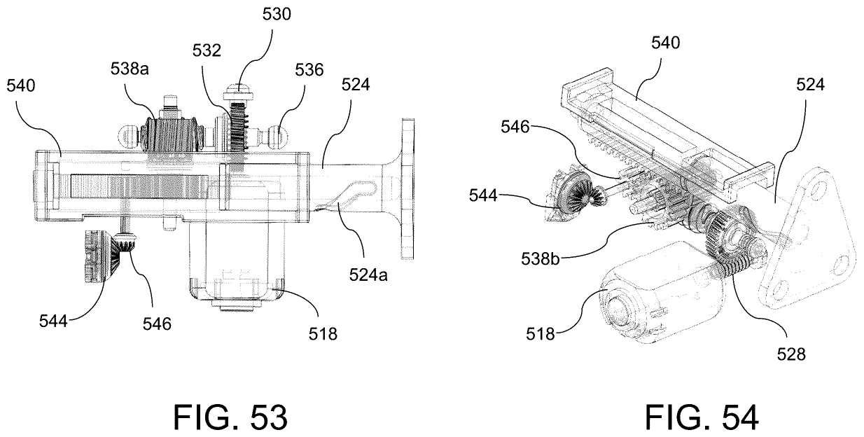

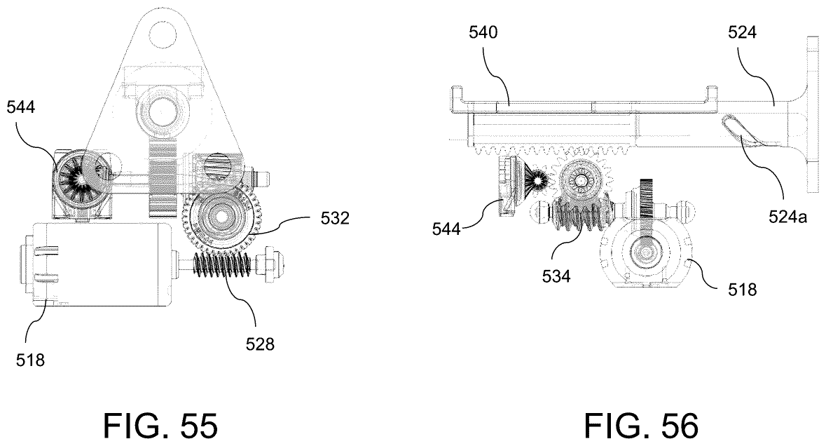

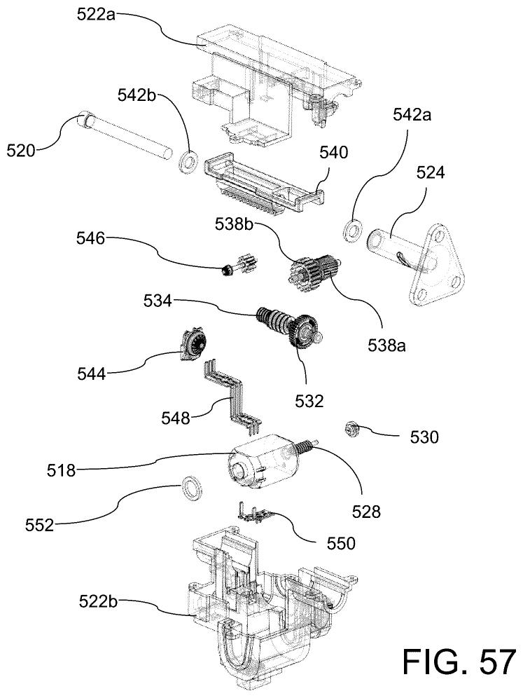

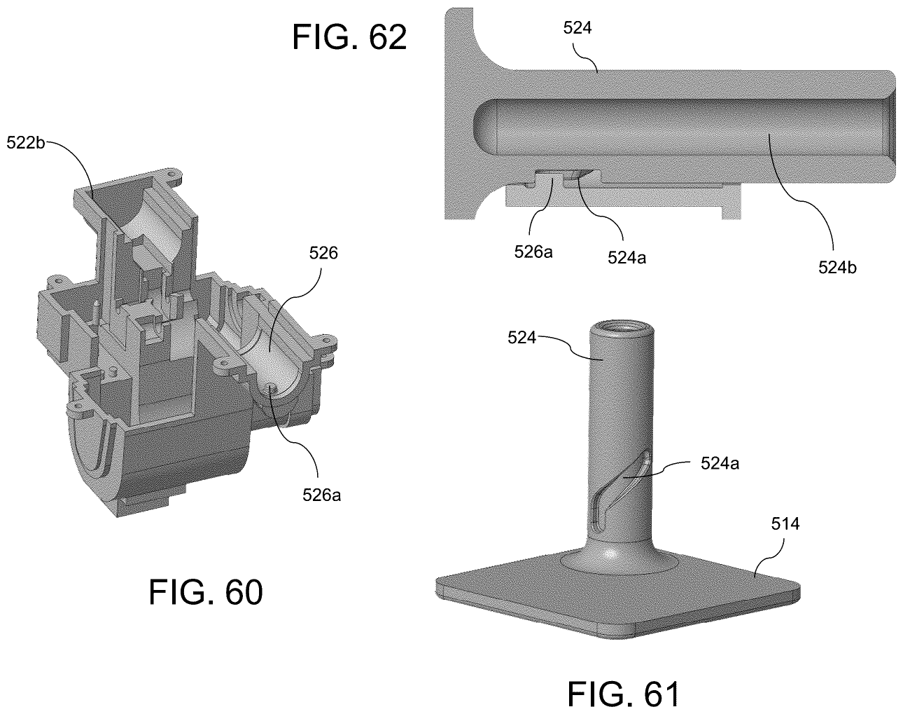

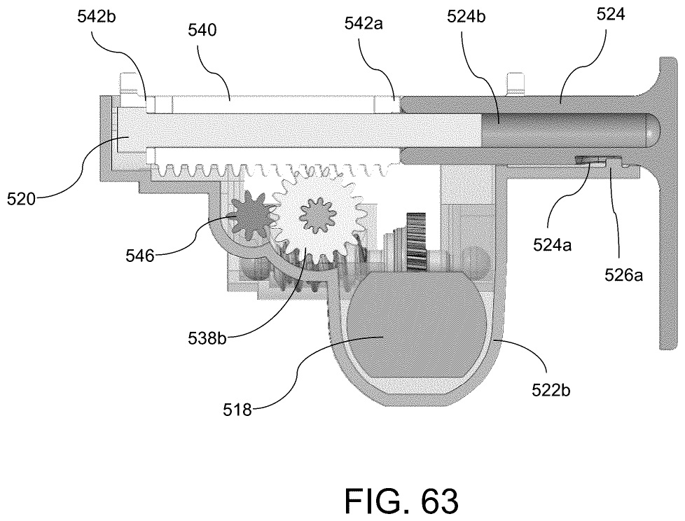

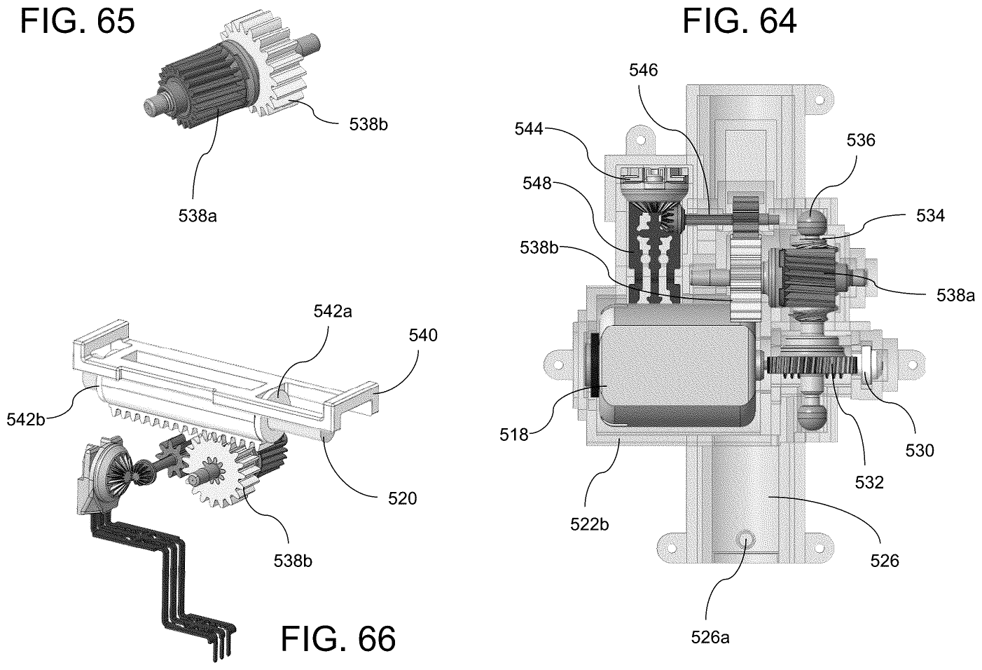

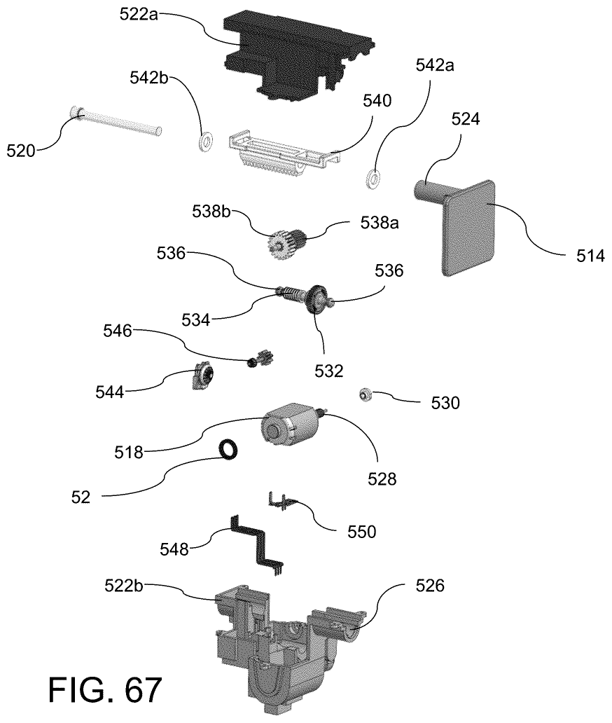

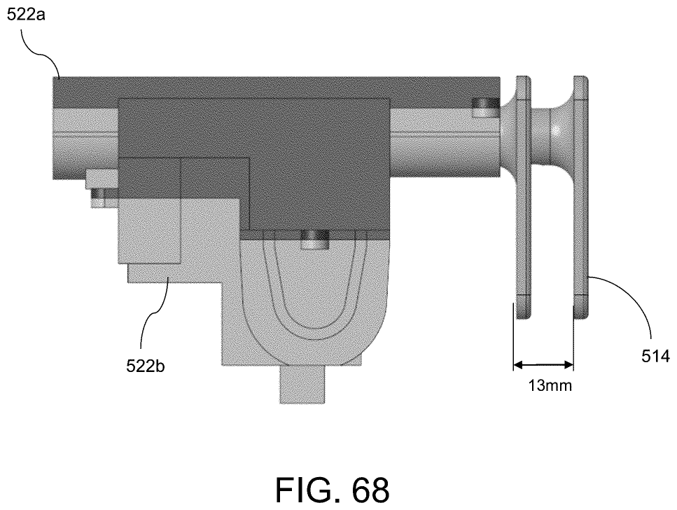

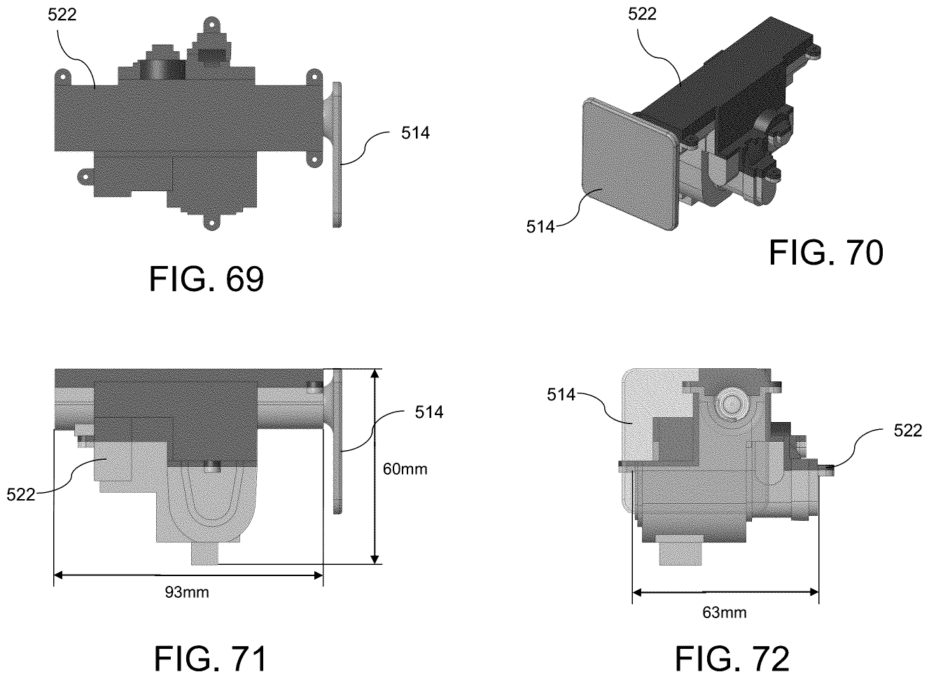

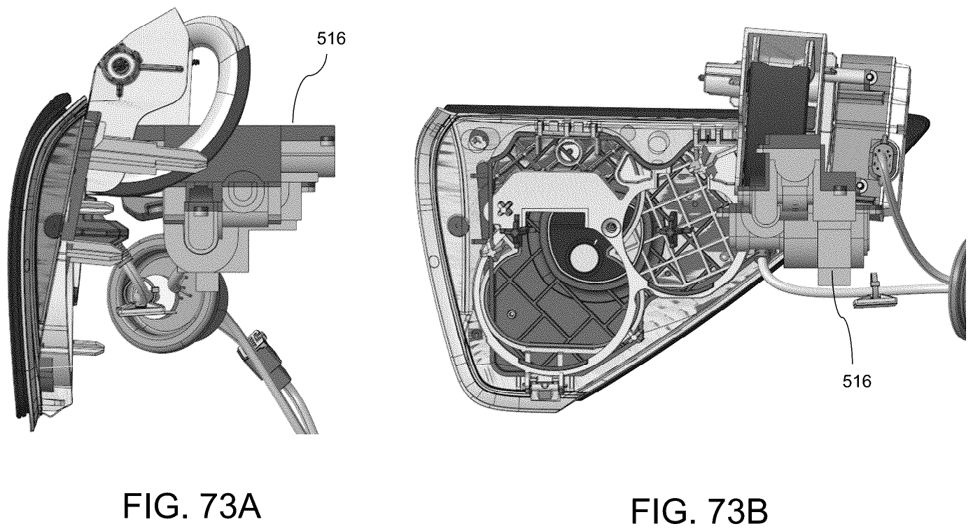

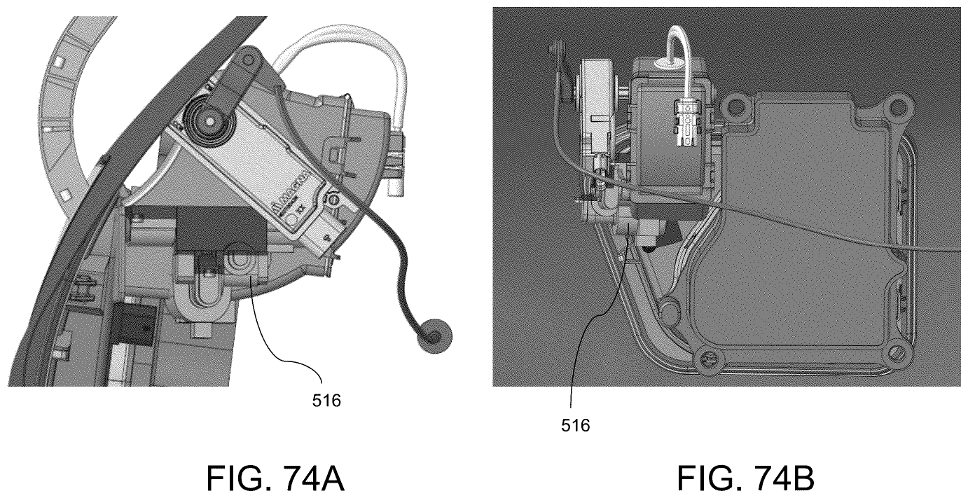

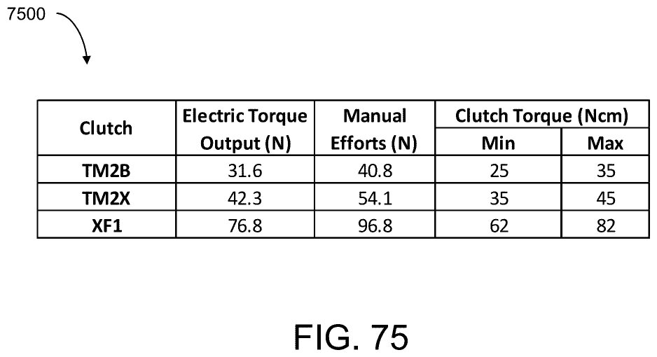

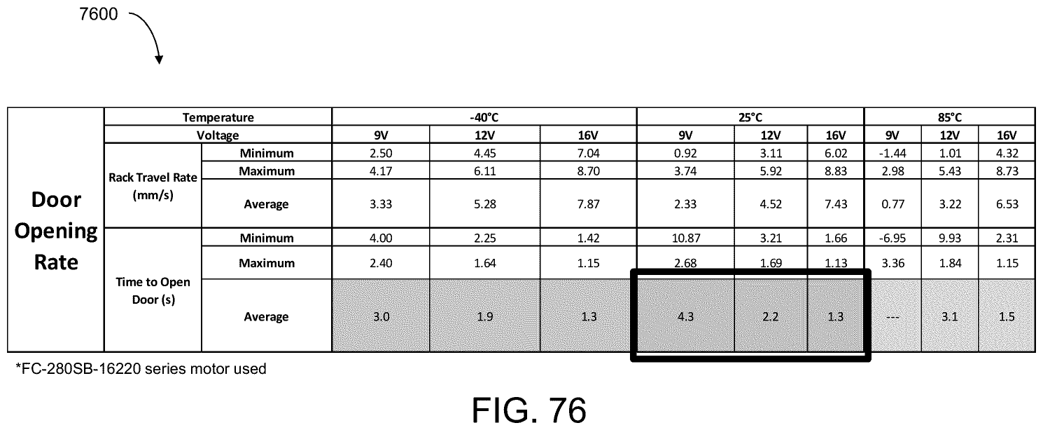

The cover panel 514 is movable between the closed position and the opened position via operation of an electrically operable actuator 516 (FIGS. 49-72), which may be electrically operated to move the cover panel in response to a user input. For example, the actuator may deploy the cover panel 514 in response to a user input at a key fob associated with the vehicle, a button or sensor at the exterior surface of the charge port 512 or vehicle, or a button at the interior of the vehicle cabin. When actuated, the actuator (such as an electrically operable motor of the actuator) operates to move the cover panel from the closed position toward the opened position, and the cover panel may move relative to the base portion or vehicle in any suitable manner, such as in a swinging or pivoting motion outward from the vehicle (such as upward or sideward from the vehicle), or in a sliding motion along the surface of the vehicle (such as along an interior surface of the body panel or an outer surface of the body panel), or in a rotating motion about a pivot axis substantially perpendicular to the surface of the vehicle (such as along the interior surface or outer surface of the body panel), and the like. For example, the cover panel and actuator may utilize characteristics of the charge ports and charging systems described in U.S. Publication No. US-2023-0191926 and/or U.S. patent application Ser. No. 18/476,632, filed Sep. 28, 2023 (Attorney Docket DON10 P4918), Ser. No. 18/419,751, filed Jan. 23, 2024 (Attorney Docket DON09 P5045), and/or Ser. No. 18/443,744, filed Feb. 16, 2024 (Attorney Docket DON10 P5080), and/or U.S. provisional application Ser. No. 63/497,457, filed Apr. 21, 2023, which are hereby incorporated herein by reference in their entireties.

An actuator with high torque output is preferred to actuate a charge port door in the closed position to compress the seal and to open the door against obstructions like ice buildup at the exterior surface of the cover panel. Further, rapid opening of the door is desired to avoid wait times for the user when opening the door to charge the vehicle. Traditionally, charge ports with cover panels movable between closed and opened positions use a hinge mechanism to open the cover panel, with electrical and manual opening options. Thus, there is not much variety in charge port cover panel or door designs. Further, a lead screw may be used to drive the cover panel between closed and opened positions. However, the lead screw may not be back drivable (e.g., for manual closing of the cover panel) without the use of an external cable, and the lead screw and corresponding nut may be complicated to mold.

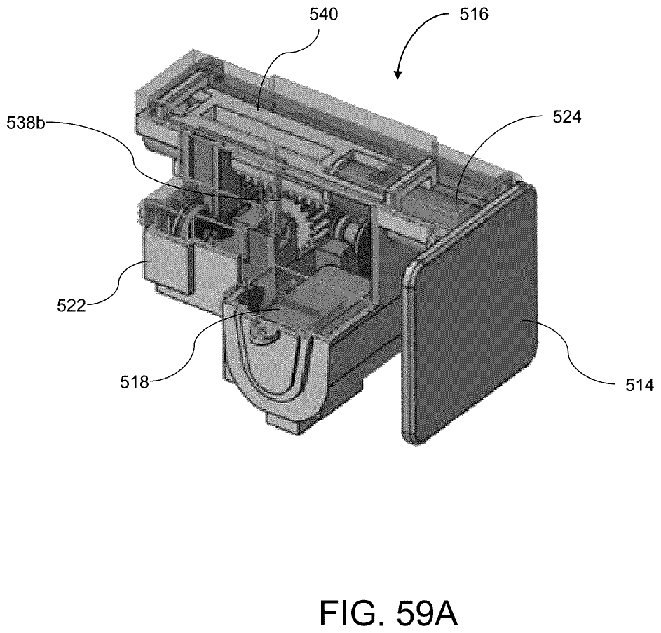

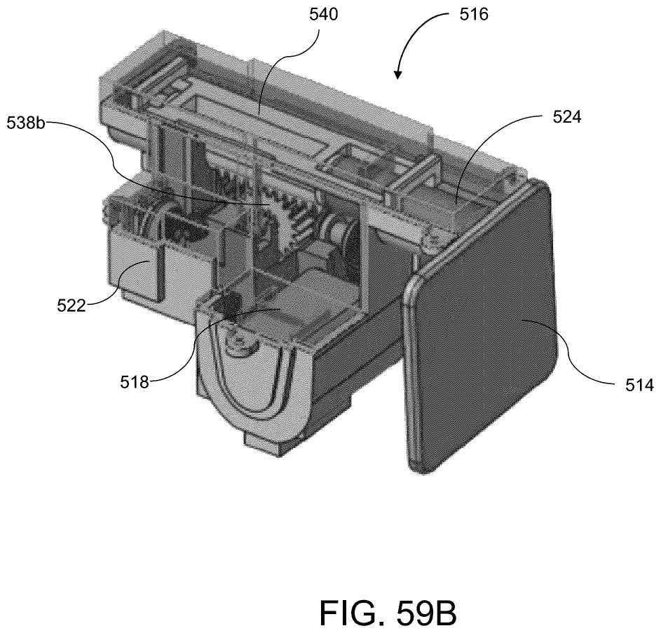

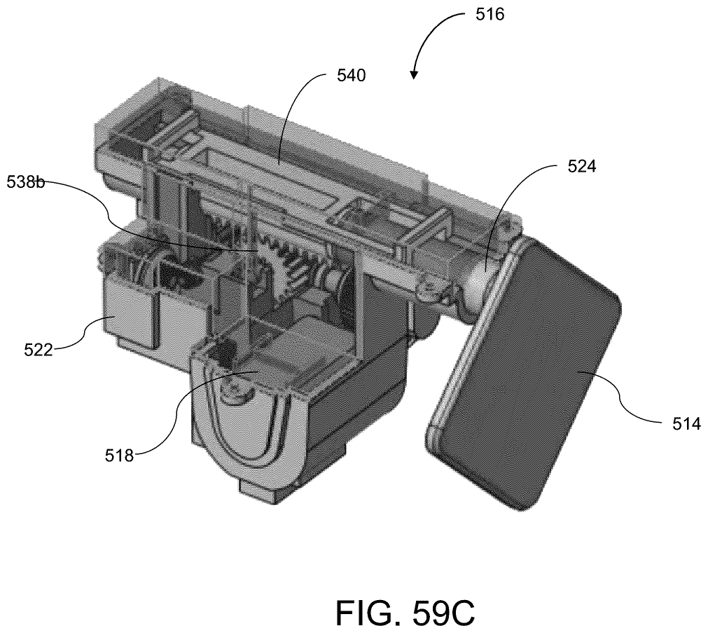

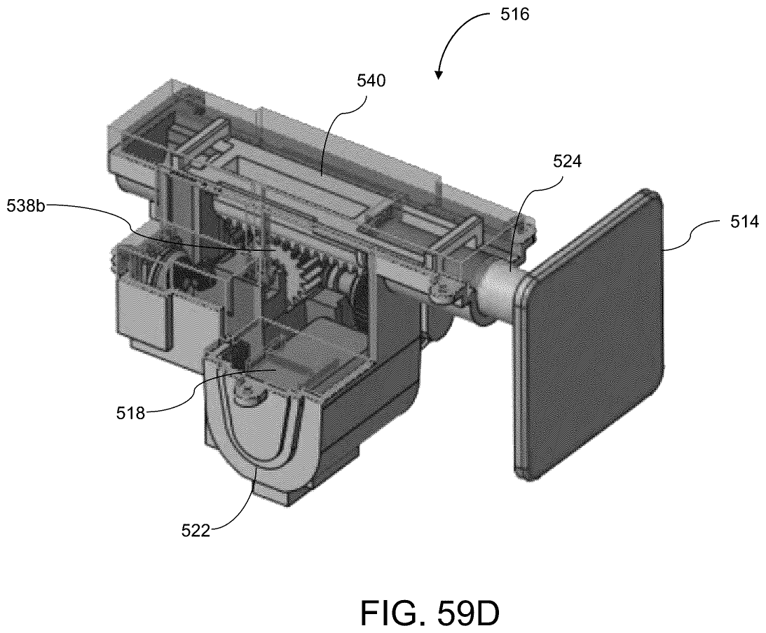

Referring to FIGS. 49-72, the actuator 516 includes an electrically operable motor 518 that, when the actuator 516 is electrically operated to move the cover panel 514 between the closed position and the opened position, is electrically operated to impart linear movement of an output element or pin 520 of the actuator 516 along a longitudinal axis of the actuator. The pin 520 is coupled to the cover panel 514 and moves between the closed position and the opened position as the pin 520 is driven during operation of the actuator 516. For example, the actuator 516 may move the pin 520 between a retracted position and an extended position relative to an actuator housing 522 (which may include a first or upper housing portion 522a and a second or inner housing portion 522b). When the pin 520 is in the retracted position relative to the housing 522, the cover panel 514 is in the closed position (e.g., FIG. 59A). As the pin 520 moves along the longitudinal axis toward the extended position, the cover panel 514 is moved toward the opened position according to movement of the pin 520 (e.g., FIG. 59D). Thus, the actuator 516 operates to move or extend the cover panel 514 from the side of the vehicle to move the cover panel 514 from the closed position toward the opened position. Optionally, the pin 520 may be in the extended position when the cover panel is in the closed position and the pin 520 may move toward the retracted position to move or retract the cover panel toward the side of the vehicle to move the cover panel 514 from the closed position toward the extended position.

The cover panel 514 or actuator assembly includes a receiving portion or output shaft 524 that extends from an interior side of the cover panel 514 and interfaces with the pin 520. The shaft 524 may be integrally formed with the cover panel 514 or include a mounting portion or plate that attaches to the interior side of the cover panel 514. The shaft 524 is received along a channel 526 that extends along the longitudinal axis of the housing 522 and the interface between the shaft 524 and channel 526 is configured to guide movement of the shaft 524 relative to the channel 526 as the pin 520 extends and retracts the shaft 524 along the channel 526 to guide movement of the cover panel 514 relative to the vehicle. For example, a slot 524a is formed along the outer surface of the shaft 524 and the slot 524a interfaces with a structure or pin feature 526a extending from a portion of the channel 526 so that, as the shaft 524 moves relative to the channel 526, the structure 526a moves along the slot 524a and guides movement of the shaft 524 and cover panel 514 relative to the actuator housing 522. As shown in FIG. 61, the slot 524a may be curved or angled relative to the longitudinal axis of the shaft 524 to guide rotation of the cover panel 514 as the cover panel 514 moves between the closed position and the opened position.

In other words, the slot 524a is formed on the shaft feature 524 that interfaces with the cover panel or door 514. The pin feature 526a along the channel 526 on the lower housing 522b rides in the slot 524a and controls axial and rotational motion of the cover panel 514. The geometry of the slot 524a can be configured for specific programs, such that the cover panel 514 may move axially and/or rotationally along any suitable path as guided by the slot 524a and pin 526a. Further, the length of the slot 524a may control the distance that the cover panel 514 extends and/or retracts relative to the side of the vehicle. The rotation of the slot 524a along the outer surface of the shaft 524 may control the rotational angle of the cover panel 514 when in the opened position as compared to the closed position. Further, the geometry of the slot 524a and structure 526a may control the opening speed of the cover panel 514 and the exterior or interior opening direction. Optionally, the slot may be formed along the channel of the actuator housing and the pin may extend from the shaft and ride along the channel to guide movement of the shaft and cover panel as the shaft moves along the channel.

The motor 518 drives the pin 520 axially relative to the channel 526 and shaft 524 via a rack and pinion interface. For example, the motor 518, when electrically operated, drives a worm gear element 528 coupled to a drive shaft of the motor 518 and a motor bushing 530 may be disposed at the end of the drive shaft of the motor 518. The worm gear 528 in turn engages and drives a main gear or helical gear 532 that is coupled to and turns with a main worm gear 534. Ball bearings 536 may be disposed at the respective ends of the helical gear 532 and worm gear 534 drive shaft. The main worm gear 534 engages and drives a first clutch gear 538a coupled to a second clutch gear 538b via a slip interface that allows the second clutch gear 538b to slip relative to the first clutch gear 538a. The second clutch gear or pinion 538b engages and drives the toothed interface of a rack gear 540. The rack 540 is coupled to the pin 520 and, when driven by the pinion 538b, drives the pin 520 linearly relative to the actuator housing 522 to move the cover panel 514 between the extended position and the opened position.

The pin 520 may be press fit along the rack 540 and extends from the rack 540 and received along an inner channel or portion 524b of the shaft 524. The pin 520 may be press fit along the inner channel 524b of the shaft 524 and/or the rack 540 may engage an end of the shaft 524 to drive movement of the shaft 524. Further, a first washer 542a may be disposed between the rack 540 and the shaft 524 to reduce friction between the rack 540 and shaft 524 when the shaft 524 rotates during opening and closing of the cover panel 514. Because the pin 520 may rotate with the shaft 524 relative to the rack 540, a second washer 542b may be disposed between an end of the pin 520 and the rack 540 to reduce friction between the rack 540 and pin 520. Thus, the rack 540 and pin 520 and/or shaft 524 may rotate freely of one another.

The pin 520 may be movable along the rack 540 and/or shaft 524 to allow for manual movement of the cover panel 514 between the opened position and the closed position. For example, with the cover panel 514 in the opened position and the pin 520 and shaft 524 extended relative to the actuator housing 522, the cover panel 514 may be manually closed by a user (such as via pushing on the cover panel 514 with a twisting motion). As the cover panel 514 is manually closed and the shaft 524 and pin 520 are retracted into the actuator housing 522, the rack 540 may remain locked in place and the pin 520 may move along the rack 540 into the housing to accommodate movement of the shaft 524 relative to the rack 540. Optionally, the pin 520 moves along the inner portion 524b of the shaft 524 to accommodate movement of the shaft 524 relative to the rack 540.

Optionally, C when a torque load is experienced at the cover panel 514 (such as due to ice buildup at the cover panel or when the cover panel is being manually moved), the first clutch gear 538a and the second clutch gear 538b may slip relative to one another to allow the rack 540 to move relative to the gear train without transferring the torque to the motor 518. For example, a friction or slip interface may be disposed between the first clutch gear 538a and the second clutch gear 538b. Thus, the cover panel 514 is manually movable and the actuator may be back drivable without the use of a cable.

The pinion gear or second clutch gear 538b may have an increased diameter and the slip clutch design may dictate output forces and opening speed of the rack and cover panel. That is, the electric torque output (i.e., the torque output provided at the cover panel when driven by the motor), such as for breaking ice buildup at the outer surface of the cover panel, and the amount of effort required to manually move the cover panel are dependent upon the torque required to cause the clutch gears to slip relative to one another. Thus, there is a tradeoff between an amount of torque or ice break force and manual effort required to manually move the cover panel, as shown in the diagram 7500 of FIG. 75.

Optionally, the actuator 516 includes a position sensor 544, such as a potentiometer, for determining position of the cover panel 514 between the closed position and the opened position. For example, an idler gear 546 may engage and be driven by the pinion gear 538b. Because the pinion gear 538b moves with the rack 540 during electric and manual movement of the cover panel 514, the idler gear 546 is driven by the pinion gear 538b during both electric movement and manual movement of the cover panel 514 and the position sensor 544 senses rotational position of the idler gear 546 for determining position of the cover panel 514. Further, an electrical connector 548, such as electrical wiring or heat staked lead frame, electrically connects the position sensor 544 to a control unit of the closure system. Thus, the closure system may determine the position of the cover panel and operate the actuator based on the position of the cover panel between the closed position and the opened position.

Electrical connection between the motor 518 and a power source of the vehicle may be provided via an electrical connector 550, such as electrical wiring or lead frame. Further, a rubber buffer 552 may be disposed between the motor 518 and the housing 522, such as to reduce vibration of the actuator during operation.

Thus, the actuator 516 uses a rack and pinion guide to control motion of the cover panel 514. As the actuator 516 is electrically operated to move the cover panel 514 from the closed position (e.g., FIG. 59A) toward the opened position (e.g., FIG. 59D), the motor 518 drives the pin 520 and rack 540 to impart linear movement of the shaft 524 and cover panel 514 from the housing 522. The channel 524a along the shaft 524 may include a straight or linear first portion so that the cover panel 514 is first moved from the closed position and extended from the side of the vehicle. With the cover panel 514 at least partially extended from the side of the vehicle (e.g., FIG. 59B), the structure 526a may begin moving along a curved or angled second portion of the channel 524a to pivot the cover panel 514 away from the charge port (e.g., counterclockwise in FIG. 59C) to the opened position (e.g., FIG. 59D).

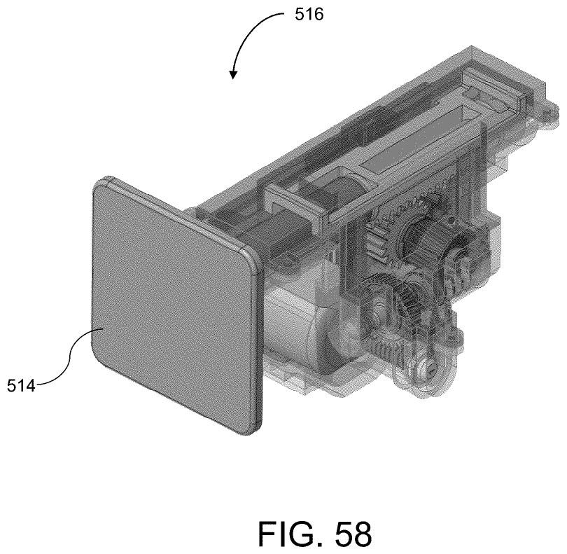

Because the actuator 516 moves in a substantially linear direction, there is no need to package or design the actuator to accommodate a hinge arm coupled to the cover panel. Thus, the actuator may have a low profile when open (such as about 13 millimeters of travel distance). The actuator may have linear travel when beginning to open. For example, rotation may begin after about 3 millimeters and the cover panel may extend 13 millimeters from the actuator (e.g., FIG. 58). This may allow for maximum ice breaking force and the linear close direction may provide a more uniform sealing around the sheet metal of the vehicle or base portion.

As shown in FIGS. 59-62, the actuator 516 has a minimal footprint, such as a width of about 63 millimeters, a height of about 60 millimeters, and a length of about 93 millimeters. Thus, the footprint of the actuator 516 may be smaller than the footprint of traditional actuators. As shown in the diagram 2900 of FIG. 76, the actuator 516 may move the cover panel 514 from the closed position to the opened position in about 2.5 seconds, with an opening distance of about 13 millimeters and an opening rotational distance of the cover panel of about 115 degrees.

Thus, the charge port may provide a cover panel that opens to the exterior or to the interior of the vehicle and operates using a unique actuator mechanism. The mechanism is electrically actuated and manually over-ridable. Further, the vehicular closure system is configured to monitor the position of the cover panel between the closed position and the opened position. Moreover, the actuator is compact in the cross-vehicle direction. No damage occurs to the actuator if movement of the cover panel or door is obstructed.

Further, the actuator provides smooth clutching, and the actuator is back drivable. The actuator provides a modular design with exterior and interior opening operability and the motion or movement profile may be tuned based on the cover panel configuration. The actuator provides high torque output for ice breaking and has a low profile when opened. The actuator provides improved sealing around the charge flap and position monitoring. A durable pin and slot may be used to prolong the life cycle of the charge flap.

Optionally, the actuator may utilize aspects of the actuators described in U.S. Publication Nos. US-2023-0027125 and/or US-2022-0341226, and/or U.S. patent applications, Ser. No. 18/359,114, filed Jul. 26, 2023 (Attorney Docket DON05 P4888), Ser. No. 18/476,632, filed Sep. 28, 2023 (Attorney Docket DON10 P4918), Ser. No. 18/414,533, filed Jan. 17, 2024 (Attorney Docket DON08 P5038), and/or Ser. No. 18/416,029, filed Jan. 18, 2024 (Attorney Docket DON08 P5040), which are hereby incorporated herein by reference in their entireties.

The charge ports described herein may be illuminated via any suitable means, and may utilize aspects of the charge ports and systems described in U.S. Pat. No. 8,317,376 and/or U.S. Publication No. US-2023-0191926, which are hereby incorporated herein by reference in their entireties. The vehicle may include various indicators to indicate the charge level of the vehicle, such as by utilizing aspects of the systems described in U.S. Pat. No. 10,746,575 and/or U.S. Pat. No. 11,318,888, which are hereby incorporated herein by reference in their entireties.

Optionally, the system and cover may operate to provide autonomous charging and may open the cover panel and pivot or move the charging connector responsive to determination of presence of the charging wand, and may control movement of the charging wand to guide the wand into electrical connection with the charging connector when the panel is opened and the connector is pivoted or moved to its charging position. The system may provide a passive way of charging electric vehicles (or plug-in hybrid vehicles or PHEVs) assisted by ultra-wideband (UWB) time of flight distance measurements (which may be made via processing of data captured by one or more time of flight sensors and/or transmitters disposed at the vehicle charge port and/or sensing or communicating with the charging wand), such as by utilizing aspects of the systems described in U.S. Publication No. US-2023-0133911, which is hereby incorporated herein by reference in its entirety. A communication gateway in communication with a PCF may automatically establish a connection with the charging station the electric vehicle is parked at. This automates the process of charging the vehicles (i.e., reduces or eliminates human intervention). The system allows for the charging station plug of the charging station to be guided to the charging socket of the electric vehicle using range and vector communication supplied by a UWB antenna system.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is positioned to allow access to a charging connector of the charge port;
an actuator that is electrically operable to move the cover panel between the closed position and the opened position;
wherein the actuator comprises an electrically operable motor that, when the actuator is electrically operated to move the cover panel between the closed position and the opened position, rotates an output gear of the actuator about an axis of rotation;
wherein an output element of the actuator is connected to the cover panel, and wherein the output element, as the cover panel moves between the closed position and the opened position, rotates about the axis of rotation;
wherein, when the electrically operable motor of the actuator is electrically operated to rotate the output gear to move the cover panel between the closed position and the opened position, the output element rotates in tandem with rotation of the output gear; and
wherein, when the cover panel is manually moved between the closed position and the opened position, the output element rotates about the axis of rotation relative to the output gear.

2. The vehicular charge port closure system of claim 1, wherein a detent interface is disposed between the output gear and the output element, and wherein, when the electrically operable motor of the actuator is electrically operated to rotate the output gear to move the cover panel between the closed position and the opened position, the detent interface is engaged so that the output element rotates in tandem with rotation of the output gear, and wherein, when the cover panel is manually moved between the closed position and the opened position, the detent interface is disengaged so that the output element rotates about the axis of rotation relative to the output gear.

3. The vehicular charge port closure system of claim 2, wherein the detent interface comprises a lower detent surface of the output gear and an upper detent surface of the output element.

4. The vehicular charge port closure system of claim 2, wherein the output element and the output gear are moved longitudinally along the axis of rotation relative to one another to engage and to disengage the detent interface.

5. The vehicular charge port closure system of claim 2, wherein the detent interface is biased toward engagement.

6. The vehicular charge port closure system of claim 1, wherein a frictional interface is disposed between the output gear and the output element, and wherein, when the cover panel is manually moved between the closed position and the opened position, the frictional interface slips and the output element rotates about the axis of rotation relative to the output gear.

7. The vehicular charge port closure system of claim 6, wherein the frictional interface is disposed between an inner cylindrical surface of the output gear and an outer cylindrical surface of the output element.

8. The vehicular charge port closure system of claim 7, wherein the frictional interface is at least partially compressed between the inner cylindrical surface of the output gear and the outer cylindrical surface of the output element.

9. The vehicular charge port closure system of claim 1, wherein the actuator comprises a position sensor that is operable to detect a rotational position of the output element about the axis of rotation.

10. The vehicular charge port closure system of claim 9, wherein a control unit of the vehicle determines a position of the cover panel between the closed position and the opened position based on the detected position of the output element about the axis of rotation.

11. The vehicular charge port closure system of claim 9, wherein the position sensor comprises a magnetic hall sensor operable to detect the rotational position of a magnet that is rotatably fixed to the output element.

12. The vehicular charge port closure system of claim 9, wherein the position sensor comprises a potentiometer.

13. The vehicular charge port closure system of claim 1, further comprising a locking element, wherein the locking element is movable between (i) a locked state, where, with the cover panel in the closed position, the locking element is engaged with a retaining element of the cover panel to secure the cover panel in the closed position, and (ii) an unlocked state, where the locking element is moved out of engagement with the retaining element of the cover panel to allow the cover panel to move between the closed position and the opened position, and wherein, with the cover panel in the closed position, the electrically operable motor of the actuator is electrically operable to rotate the output gear to move the locking element between the locked state and the unlocked state.

14. The vehicular charge port closure system of claim 13, wherein a second output element of the actuator is connected to the locking element, and wherein, when the electrically operable motor of the actuator is electrically operated to move the locking element between the locked state and the unlocked state, the output gear rotates the second output element about the axis of rotation to move the locking element between the locked state and the unlocked state.

15. The vehicular charge port closure system of claim 14, wherein the second output element rotates about the axis of rotation in a first direction to move the locking element from the locked state toward the unlocked state, and wherein the second output element rotates about the axis of rotation in a second direction to move the locking element from the unlocked state toward the locked state, and wherein the second direction is opposite the first direction.

16. The vehicular charge port closure system of claim 15, wherein a link connects the second output element and the locking element, and wherein, when the second output element rotates about the axis of rotation to move the locking element between the locked state and the unlocked state, the locking element pivots relative to the cover panel.

17. The vehicular charge port closure system of claim 14, wherein the output gear rotates the output element and the second output element together and in tandem with one another.

18. The vehicular charge port closure system of claim 17, wherein the output gear drives a planetary gear system that rotates the output element and the second output element.

19. The vehicular charge port closure system of claim 14, wherein, when the electrically operable motor of the actuator is electrically operated and with the locking element in the locked state, rotation of the output element about the axis of rotation is constrained in a first direction and the output gear rotates the second output element about the axis of rotation in an opposite second direction to move the locking element toward the unlocked state.

20. The vehicular charge port closure system of claim 19, wherein, when the electrically operable motor of the actuator is electrically operated and with the locking element in the unlocked state and with the cover panel in the closed position, rotation of the second output element about the axis of rotation is constrained in the first direction and, when the output gear rotates the output element about the axis of rotation in the second direction, the cover panel moves toward the opened position.

21. The vehicular charge port closure system of claim 13, wherein the locking element is biased from the unlocked state toward the locked state.

22. The vehicular charge port closure system of claim 13, wherein, with the locking element moved to the unlocked state, a pawl is moved into engagement with the locking element to preclude the locking element from moving toward the locked state.

23. The vehicular charge port closure system of claim 22, wherein, with the pawl engaged with the locking element and when the cover panel is moved to the closed position, the retaining element of the cover panel engages the pawl to move the pawl out of engagement with the locking element to allow the locking element to move toward the locked state.

24. The vehicular charge port closure system of claim 22, wherein the pawl is biased toward engagement with the locking element.

25. The vehicular charge port closure system of claim 13, wherein, when the locking element is moved from the locked state toward the unlocked state, the locking element engages the cover panel to urge the cover panel at least partially toward the opened position.

26. The vehicular charge port closure system of claim 13, wherein, when the locking element is moved from the unlocked state toward the locked state and as the locking element engages the retaining element, the locking element applies a retaining force at the cover panel to at least partially compress a sealing element disposed between the cover panel and a base portion of the charge port.

27. The vehicular charge port closure system of claim 1, wherein, when the electrically operable motor is electrically operated to rotate the output gear, the electrically operable motor provides a constant torque output, and wherein the actuator comprises a variable torque profile so that, as the electrically operable motor is electrically operated to rotate the output gear, the output element provides a non-constant torque output at the cover panel.

28. The vehicular charge port closure system of claim 1, wherein the output element of the actuator comprises an output shaft, and wherein, as the cover panel moves between the closed position and the opened position, the output shaft moves axially along the axis of rotation and rotates about the axis of rotation, and wherein, as the cover panel moves between the closed position and the opened position, the output shaft rotates about the axis of rotation according to a pin of the actuator received along a channel formed along the output shaft.

29. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is positioned to allow access to a charging connector of the charge port;
an actuator that is electrically operable to move the cover panel between the closed position and the opened position;
wherein the actuator comprises an electrically operable motor that, when the actuator is electrically operated to move the cover panel between the closed position and the opened position, rotates an output gear about an axis of rotation;
wherein an output element of the actuator is connected to the cover panel, and wherein the output element, as the cover panel moves between the closed position and the opened position, pivots about the axis of rotation;
wherein, when the electrically operable motor of the actuator is electrically operated to rotate the output gear to move the cover panel between the closed position and the opened position, the output element pivots about the axis of rotation to move the cover panel between the closed position and the opened position; and
wherein, when the electrically operable motor of the actuator is electrically operated to rotate the output gear, the electrically operable motor provides a constant torque output, and wherein the actuator comprises a variable torque profile so that, as the electrically operable motor of the actuator is electrically operated to rotate the output gear, the output element provides a non-constant torque output at the cover panel.

30. The vehicular charge port closure system of claim 29, wherein, when the cover panel moves between the closed position and the opened position, the cover panel pivots about a pivot axis, and wherein the pivot axis of the cover panel is offset from the axis of rotation.

31. The vehicular charge port closure system of claim 30, wherein the output element comprises a pivot link connected to the cover panel and the output gear, and wherein the pivot link comprises (i) a first portion that is coupled to the output gear and that pivots about the axis of rotation according to rotation of the output gear and (ii) a second portion that has a first end pivotally connected to the first portion and a second end opposite the first end pivotally connected to the cover panel, and wherein, when the electrically operable motor of the actuator is electrically operated to rotate the output gear to move the cover panel between the closed position and the opened position, the electrically operable motor rotates the output gear and the first portion of the pivot link pivots about the axis of rotation to impart movement of the cover panel about the pivot axis of the cover panel via the second portion of the pivot link.

32. The vehicular charge port closure system of claim 31, wherein, when the cover panel moves between the closed position and the opened position, the first end of the second portion of the pivot link moves about the axis of rotation and the second end of the second portion of the pivot link moves about the pivot axis of the cover panel.

33. The vehicular charge port closure system of claim 31, wherein the cover panel comprises a hinge arm that pivots about the pivot axis of the cover panel, and wherein the second end of the second portion of the pivot link is pivotally connected to the hinge arm of the cover panel.

34. The vehicular charge port closure system of claim 31, wherein the second portion of the pivot link is curved.

35. The vehicular charge port closure system of claim 34, wherein, with the cover panel in the closed position, the second portion of the pivot link is concentric with the axis of rotation.

36. The vehicular charge port closure system of claim 34, wherein, with the cover panel in the opened position, the second portion of the pivot link is concentric with the pivot axis of the cover panel.

37. The vehicular charge port closure system of claim 34, wherein, as the cover panel moves between the closed position and the opened position, a center point of the curved second portion of the pivot link shifts relative to the pivot axis of the cover panel and the axis of rotation according to the non-constant torque output at the cover panel.

38. The vehicular charge port closure system of claim 31, wherein the pivot axis of the cover panel is parallel to and spaced from the axis of rotation.

39. The vehicular charge port closure system of claim 29, wherein a sealing element is disposed at a base portion of the charge port, and wherein the cover panel, when in the closed position, compresses the sealing element between the cover panel and the base portion.

40. The vehicular charge port closure system of claim 29, wherein the actuator drives a gear train to rotate the output gear.

41. The vehicular charge port closure system of claim 40, wherein the gear train comprises a first nautilus gear and the output gear comprises a second nautilus gear engaging the first nautilus gear.

42. The vehicular charge port closure system of claim 41, wherein a gear ratio between the first nautilus gear and the second nautilus gear decreases as the electrically operable motor of the actuator is electrically operated to rotate the output gear to move the cover panel from the closed position toward the opened position according to the non-constant torque output at the cover panel.

43. The vehicular charge port closure system of claim 41, wherein a gear ratio between the first nautilus gear and the second nautilus gear increases as the electrically operable motor of the actuator is electrically operated to rotate the output gear to move the cover panel from the opened position toward the closed position according to the non-constant torque output at the cover panel.

44. The vehicular charge port closure system of claim 40, wherein the gear train comprises a detent interface disposed between the output gear and the output element, and wherein, when the electrically operable motor of the actuator is electrically operated to rotate the output gear to move the cover panel between the closed position and the opened position, the detent interface is engaged so that the output element pivots in tandem with rotation of the output gear, and wherein, when the cover panel is manually moved between the closed position and the opened position, the detent interface is disengaged so that the output element pivots about the axis of rotation relative to the output gear.

45. The vehicular charge port closure system of claim 29, wherein the torque output at the cover panel decreases as the electrically operable motor of the actuator is electrically operated to move the cover panel from the closed position toward the opened position.

46. The vehicular charge port closure system of claim 29, wherein speed of the cover panel increases as the electrically operable motor of the actuator is electrically operated to move the cover panel from the closed position toward the opened position.

47. The vehicular charge port closure system of claim 29, wherein the output element of the actuator comprises an output shaft, and wherein, as the cover panel moves between the closed position and the opened position, the output shaft moves axially along the axis of rotation and pivots about the axis of rotation, and wherein, as the cover panel moves between the closed position and the opened position, the output shaft pivots about the axis of rotation according to a pin of the actuator received along a channel formed along the output shaft.

48. A vehicular charge port closure system, the vehicular charge port closure system comprising:
a cover panel disposed at a charge port of a vehicle equipped with the vehicular charge port closure system, wherein the cover panel is movable between (i) a closed position where the cover panel conceals the charge port of the vehicle and (ii) an opened position where the cover panel is positioned to allow access to a charging connector of the charge port;
an actuator that is electrically operable to move the cover panel between the closed position and the opened position;
wherein the actuator comprises an electrically operable motor that, when the actuator is electrically operated to move the cover panel between the closed position and the opened position, drives a gear train of the actuator;
wherein an output shaft of the actuator is coupled to the cover panel, and wherein, as the cover panel moves between the closed position and the opened position, the output shaft moves together and in tandem with the cover panel;
wherein the gear train of the actuator is coupled to a rack that extends along a longitudinal axis of the actuator, and wherein the rack is coupled to the output shaft and moves with the output shaft along the longitudinal axis as the cover panel moves between the closed position and the opened position; and
wherein, when the electrically operable motor of the actuator is electrically operated to drive the gear train, the gear train of the actuator drives the rack to move the output shaft along the longitudinal axis to move the cover panel between the closed position and the opened position.

49. The vehicular charge port closure system of claim 48, wherein a channel is formed along an outer surface of the output shaft, and wherein a guide pin is received along the channel, and wherein, as the output shaft moves along the longitudinal axis to move the cover panel between the closed position and the opened position, the guide pin moves along the channel and guides rotation of the output shaft and cover panel about the longitudinal axis.

50. The vehicular charge port closure system of claim 49, wherein the actuator comprises a housing that accommodates the electrically operable motor, the gear train, and at least a portion of the output shaft, and wherein the output shaft moves along a channel of the housing as the cover panel moves between the closed position and the opened position, and wherein the guide pin is formed along the channel of the housing.

51. The vehicular charge port closure system of claim 48, wherein a clutch is coupled between the rack and the gear train, and wherein, when the cover panel is manually moved between the closed position and the opened position, the clutch decouples the rack from the gear train.

52. The vehicular charge port closure system of claim 51, wherein, when the cover panel is manually moved between the closed position and the opened position and with the rack decoupled from the gear train, the rack does not impart movement of the gear train.

53. The vehicular charge port closure system of claim 48, wherein the actuator comprises a position sensor operable to determine a position of the cover panel between the closed position and the opened position.

54. The vehicular charge port closure system of claim 53, wherein the position sensor detects a position of the rack along the longitudinal axis to determine the position of the cover panel between the closed position and the opened position.

55. The vehicular charge port closure system of claim 53, wherein the position sensor comprises a potentiometer.

56. The vehicular charge port closure system of claim 48, wherein the rack is coupled to the output shaft via a pin that extends from the rack and that is at least partially received along the output shaft.

57. The vehicular charge port closure system of claim 48, wherein, when the cover panel moves from the closed position toward the opened position, the output shaft is extended from the actuator.

58. The vehicular charge port closure system of claim 48, wherein, when the cover panel moves from the closed position toward the opened position, the output shaft is retracted along the longitudinal axis toward the actuator.

59. The vehicular charge port closure system of claim 48, wherein, when the electrically operable motor is electrically operated to drive the gear train, the electrically operable motor provides a constant torque output, and wherein the actuator comprises a variable torque profile so that, as the electrically operable motor is electrically operated to drive the gear train, the gear train provides a non-constant torque output at the cover panel.
